(19) United States
(12) Patent Application Publication
(10) Pub. No.: US 2013/0204862 A1
(43) Pub. Date: Aug. 8, 2013

(54) INTERNET SEARCHING AND SOCIAL INTERACTION TECHNIQUES

(71) Applicant: Massimo Marchiori, Venice (IT)

(72) Inventor: Massimo Marchiori, Venice (IT)

(73) Assignee: VOLUNIA ITALIA S.R.L., Milan (IT)

(21) Appl. No.: 13/366,093

(22) Filed: Feb. 3, 2012

(51) Int. Cl. G06F 17/30; G06F 3/0481

(52) U.S. Cl. CPC G06F 17/30554; G06F 3/04817
USPC 707/722; 715/760

(57) ABSTRACT

According to techniques of this application, a method for presenting data representative of a website includes associating a plurality of webpage icons with a corresponding plurality of webpages in a website. Each of the webpage icons correspond to differing degrees of significance of the webpages. Each of the webpage icons are communicative of the differing degrees of significance of the webpages (for example the first webpage icon may be larger than the second webpage icon). There may be two, three, or more webpage icons that are communicative of differing degrees of significance of the webpages. The webpage icons are positioned in different areas of map view data. The map view data may be transmitted for presentation on a display.

### BACKGROUND

Generally, this application discloses techniques for searching the World-Wide Web (“WWW”) and allowing social interactions in conjunction with search results. This application also discloses techniques for presenting websites and webpages in a variety of visualizations.

WWW Search Results

FIG. 1 illustrates a display of a browser window 1 showing search results 3. The display may include a search form 2, and a search icon. A search phrase (“insects”) has been entered into the search form 2 and search results 3 have been returned. Each search result 3 corresponds to a webpage (which may also be referred to as a page) and includes a title 4, a URL 5, an abstract 6, or a preview icon 8. The webpage may be a part of a website (for example, the collection of webpages available at a domain). The title 4 and/or the URL 5 may have an embedded hyperlink directing navigation to the appropriate webpage. The abstract 6 may include a textual description of the content of the webpage.

Some search results 3 may also include sub-results 7 to other webpages on the website. Similar to a search result 3, a sub-result 7 may include a title, a URL, an abstract, or a preview icon. The search engine display may also include a preview 9 of the webpage associated with a search result 3 or a sub-result 7. The preview 9 may be a screen-shot of the webpage. The preview may appear by hovering over or clicking on the preview icon 8.

The abstract 6 and the preview 9 may be intended to provide a user with some information about the content of the webpage. Such information may be useful for deciding whether or not the webpage is relevant to the user's interest. However, the abstract 6 may be insufficient or poorly reflective of the webpage's content (for example, too brief, too narrow, lacking context, etc.). Also, the preview 9 may be relatively small and difficult to read.

The sub-results 7 may be intended to provide a user with several specific options for navigating a website. For example, a sub-result 7 may be intended to provide direct navigation to a webpage of interest to the user. However, the sub-results 7 may reflect only a portion of the whole website. Also, the sub-results 7 may be chosen for reasons irrelevant to the user's interests. For example, the sub-results 7 may be chosen based on an amount of web traffic to particular pages on the website. Such traffic may not be relevant to the user's interests. Furthermore, the sub-results 7 may not provide any indication of the overall structure, organization, and content of the website.

Social Networks

Presently, social networks (for example, Facebook®, Twitter®, LinkedIn®, MySpace®, etc.) may require a user to register or log in. The user may have a unique identity and the ability to define interests, passions, work experience, relationships, and so on. The user may invite friends to be part of a network, for example, by identifying other people based on such information.

Such social networks may be localized. For example, such networks may operate independently of each other. For example, if one user wishes to participate in the different networks, the user may require multiple registrations, user names, passwords, or the like. Furthermore, the social interactions within one network may not be viewable or accessible by other networks.

Such social networking or interaction opportunities may be limited. For example, social networks may only be available to users who register. Also, it may not be possible to effectively connect with other users based on the limited amount of information available about another user and the somewhat arbitrary or random nature of viral networks.

Outside of such social networks, opportunities for socially interacting may also be limited. For example, some webpages may natively provide opportunities to post comments or to chat with other visitors at that particular webpage. Presently, the WWW may have perhaps hundreds of millions of domains and perhaps trillions of publicly available individual webpages. Currently, webpages that provide native social interaction functionality represent a fraction of the webpages on the WWW.

### SUMMARY

According to techniques of this application, a method for generating map view data representative of at least a portion of a website includes associating a first webpage icon with a first webpage of the website and associating a second webpage icon with a second webpage of the website. The first webpage icon may correspond to a degree of significance of the first webpage, and the second webpage icon may correspond to a degree of significance of the second webpage. The method may further include positioning the first webpage icon in a first area of the map view data, and positioning the second webpage icon in a second area of the map view data. The method may also include transmitting the map view data for presentation on a display.

The first webpage icon may be different than the second webpage icon (for example, the webpage icons may be depictions of different buildings). The degree of significance of the first webpage may be different than the degree of significance of the second webpage. The first webpage icon may be communicative of the degree of significance of the first webpage. The second webpage icon may be communicative of the degree of significance of the first webpage. For example, the first webpage icon may be larger than the second webpage icon.

The method may include positioning text associated with the first webpage of the website proximate to the first webpage icon, and positioning text associated with the second webpage of the website proximate to the second webpage icon.

The method may include associating a third webpage icon with a third webpage of the website, wherein the third webpage icon corresponds to a degree of significance of the third webpage. The method may also include receiving a zoom-in signal and, in response to the zoom-in signal, positioning the third webpage icon in the first area of the map view data. The third webpage icon may be communicative of the degree of significance of the third webpage. The third webpage icon and the second webpage icon are substantially the same. The third webpage icon may be smaller than the first webpage icon. The first webpage and the second webpage are at different levels of the website, and wherein the level of the first webpage may be higher than the level of the second webpage. The method may include receiving a zoom-out signal and, in response to the zoom-out signal, removing the third webpage icon.

The method may include positioning a perimeter representation around the first area of the map view data, and positioning a perimeter representation around the second area of the map view data. The method may also include loading webpage data from the corresponding webpage in response to an icon interaction signal associated with one of the icons.

The method may include positioning a first social icon proximate to the first webpage icon, and positioning a second social icon proximate to the second webpage icon. The method may include loading first social view data in response to a first social icon interaction signal, and loading second social view data in response to a second social icon interaction signal. The first social view data may include social information generated by a plurality of users while they were visiting the first webpage. The second social view data may include social information generated by a plurality of users while they were visiting the second webpage.

According to techniques of this application, a method for generating container view data representative of at least a portion of a website may include associating a first container icon with a first webpage of the website, associating a second container icon with a second webpage of the website, nesting the second container icon within the first container icon, including the first container icon in the container view data, and, in response to a first type of icon interaction signal associated with the first container icon, including the second container icon in the container view data. The first webpage may correspond to a first level of the website. The second webpage may correspond to a second level of the website. The method may include transmitting the container view data for presentation on a display.

The method may include obtaining webpage data for the first webpage of the website in response to a second type of icon interaction signal associated with the first container icon. The method may include transmitting the webpage data for presentation on a display.

The method may include positioning a first social icon proximate to the first container icon and positioning a second social icon proximate to the second container icon. The method may include loading first social view data in response to a first social icon interaction signal, and loading second social view data in response to a second social icon interaction signal. The first social view data may include social information generated by a plurality of users while they were visiting the first webpage. The second social view data may include social information generated by a plurality of users while they were visiting the second webpage.

According to techniques of this application, a method for generating search result view data may include including a plurality of rows in the search result view data. At least a portion of the plurality of rows each may include information descriptive of a webpage and at least one of a map view icon or a container view icon. The map view icon may correspond to a map view of the website. The container view icon may correspond to a container view of the website. The method may include transmitting the search result view data for presentation on a display. The plurality of rows may each comprise a social icon.

The method may include receiving a map view icon interaction signal with the map view icon, and responsively including map view data corresponding to the website in the search result view data. The map view icon interaction signal may include a signal indicating a pointer hovering over the map view icon. The method may include receiving a container view icon interaction signal, and including container view data corresponding to the website in the search result view data. The container view icon interaction signal may include a signal indicating a pointer hovering over the container view icon. The information descriptive of the webpage may include a hyperlink to the webpage and an abstract of the webpage

According to techniques of this application, a method for facilitating social communications associated with at least one webpage may include including a first row comprising information descriptive of a first webpage and a first social icon in search result view data, and including a second row comprising information descriptive of a second webpage and a second social icon in the search result view data. The first social icon may indicate that a plurality of users is interacting in conjunction with the first webpage. The second social icon may indicate that no users are interacting in conjunction with the second webpage. The method may include transmitting the search result view data for presentation on a display. The first social icon may indicate a number of users that are interacting in conjunction with the first webpage. The first social icon may indicate a number of users that are interacting in conjunction with a first website containing the first webpage. The first social icon and the second social icon may have different appearances.

The method may include receiving a first social icon interaction signal through the first social icon, and including in social communications data, a dialogue area for presenting social communications between users in response to receiving the first social icon interaction signal. The method may include obtaining webpage data corresponding to the first webpage in response to receiving the first social icon interaction signal. The markup language may include hyper-text markup language (“HTML”). The method may include transmitting the social communications data and the webpage data for presentation on a display.

According to techniques of this application, a method for facilitating social communications associated with at least a first webpage and a second webpage may include associating first social view data with first webpage view data to form first associated data. The method may also include associating second social view data with second webpage view data to form second associated data. The second social view data may be different from the first social view data. The second webpage view data may be different from the first webpage view data. The first social view data may include social communications received from a first plurality of users visiting the first webpage. The second social view data may include social communications received from a second plurality of users visiting the second webpage. The first plurality of users may be different from the second plurality of users

The method may also include transmitting the first associated data for presentation on a display and subsequently receiving a navigation signal to navigate to the second webpage. The method may also include responsively transmitting the second associated data for presentation on the display in place of the first associated data.

### BRIEF DESCRIPTION OF SEVERAL VIEWS OF THE DRAWINGS

FIG. 1 illustrates a display of a browser window showing search results.

FIGS. 2-3 illustrate a browsing application displaying a home page, according to techniques of this application.

FIGS. 4-7 illustrate a browsing application displaying search result views including pop-up views, according to techniques of this application.

FIG. 8 illustrates a browsing application displaying a webpage, according to techniques of this application.

FIGS. 9-13 illustrate a browsing application displaying map views of a website, according to techniques of this application.

FIG. 14-16 illustrate a browsing application displaying container views of a website, according to techniques of this application.

FIG. 17 illustrates a browsing application displaying a webpage, according to techniques of this application.

FIG. 18 illustrates a browsing application displaying a webpage and a media menu, according to techniques of this application.

FIGS. 19-20 illustrate a browsing application displaying document views, according to techniques of this application.

FIGS. 21-22 illustrate a browsing application displaying a people toolbar, according to techniques of this application.

FIGS. 23A and 23B illustrate a browsing application displaying sharing features, according to techniques of this application.

FIGS. 24-28 illustrate a browsing application displaying user account information, according to techniques of this application.

FIGS. 29-31 illustrate a browsing application displaying another user's or friend's information, according to techniques of this application.

FIG. 32 illustrates a browsing application displaying search result views including indications of social activity, according to techniques of this application.

FIG. 33 illustrates a browsing application displaying a webpage and indications of social activity in conjunction with the webpage, according to techniques of this application.

FIG. 34 illustrates a browsing application displaying a webpage and social interactions in conjunction with the webpage, according to techniques of this application.

FIGS. 35-36 illustrate a browsing application displaying map views of a website and indications of social activity in conjunction with the website, according to techniques of this application.

FIG. 37 illustrates a browsing application displaying a webpage and social interactions in conjunction with the webpage, according to techniques of this application.

FIG. 38 illustrates a browsing application displaying another user's information and social interactions in conjunction with the user's information, according to techniques of this application.

FIG. 39 illustrates a browsing application displaying a webpage and social interactions in conjunction with the webpage, according to techniques of this application.

FIG. 40 illustrates a system for implementing a browsing application, according to techniques of this application.

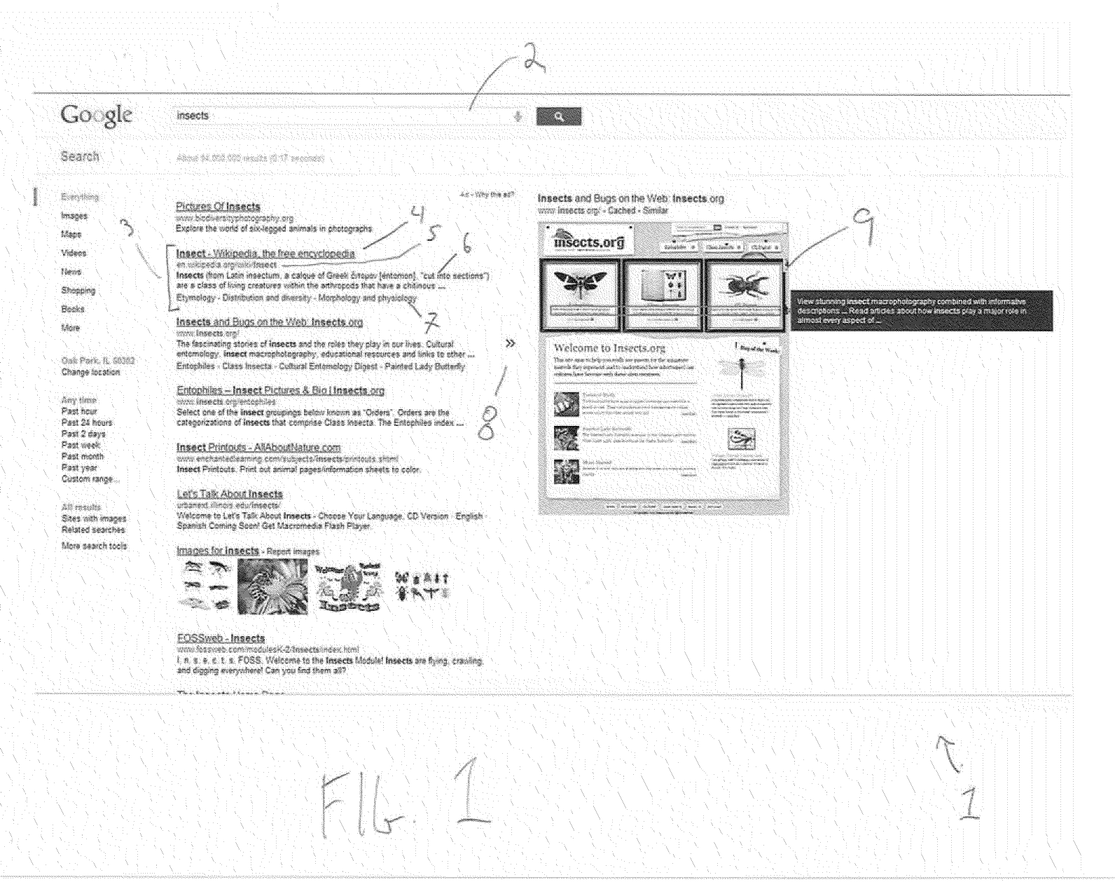

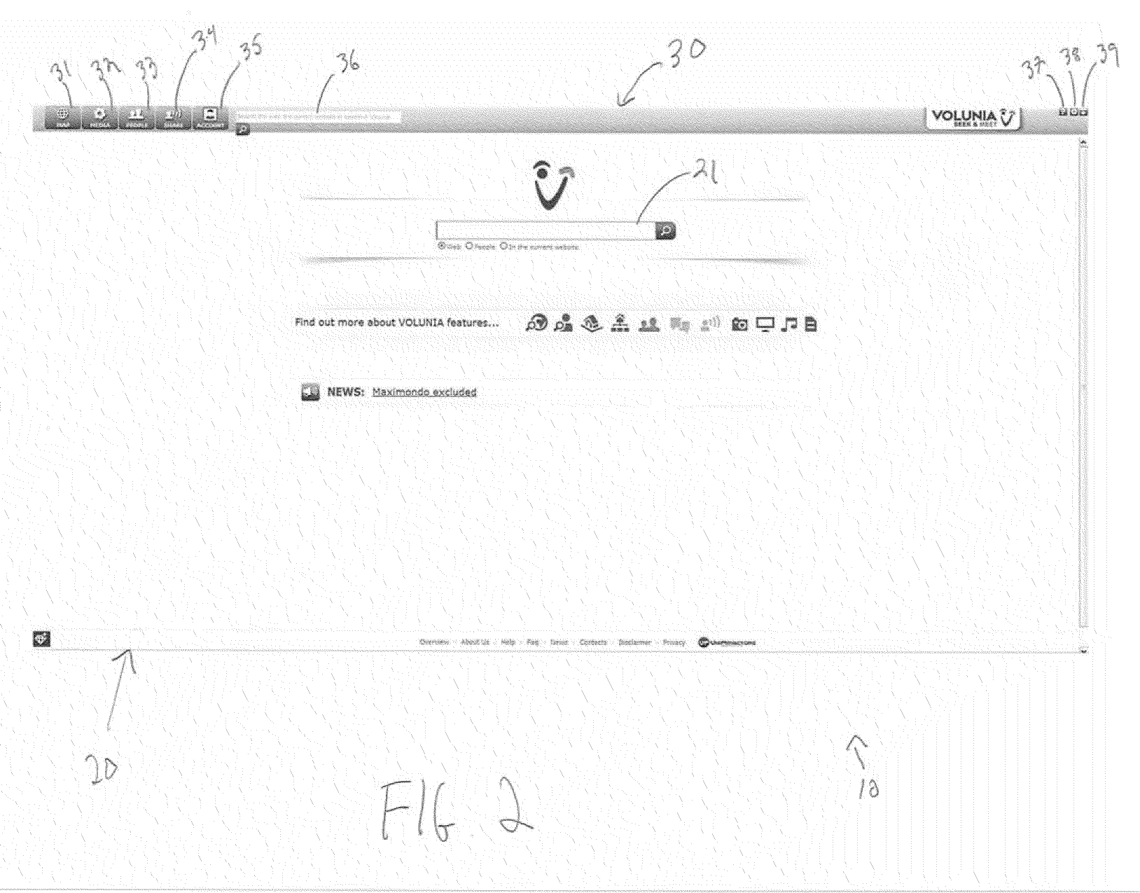

The foregoing summary, as well as the following detailed description of certain embodiments of the present invention, will be better understood when read in conjunction with the appended drawings. For the purposes of illustration, certain embodiments are shown in the drawings. It should be understood, however, that the claims are not limited to the arrangements and instrumentalities shown in the attached drawings. Furthermore, the appearance shown in the drawings is one of many ornamental appearances that can be employed to achieve the stated functions of the system.

### DETAILED DESCRIPTION

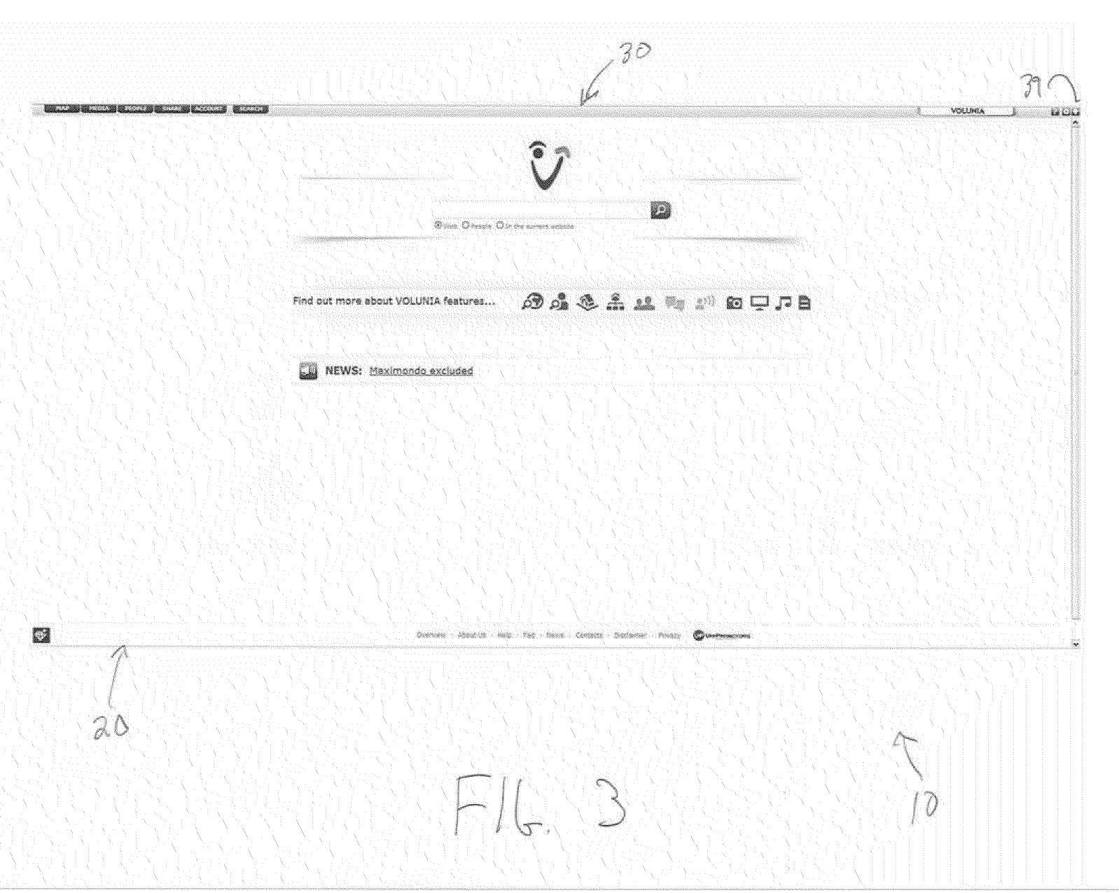

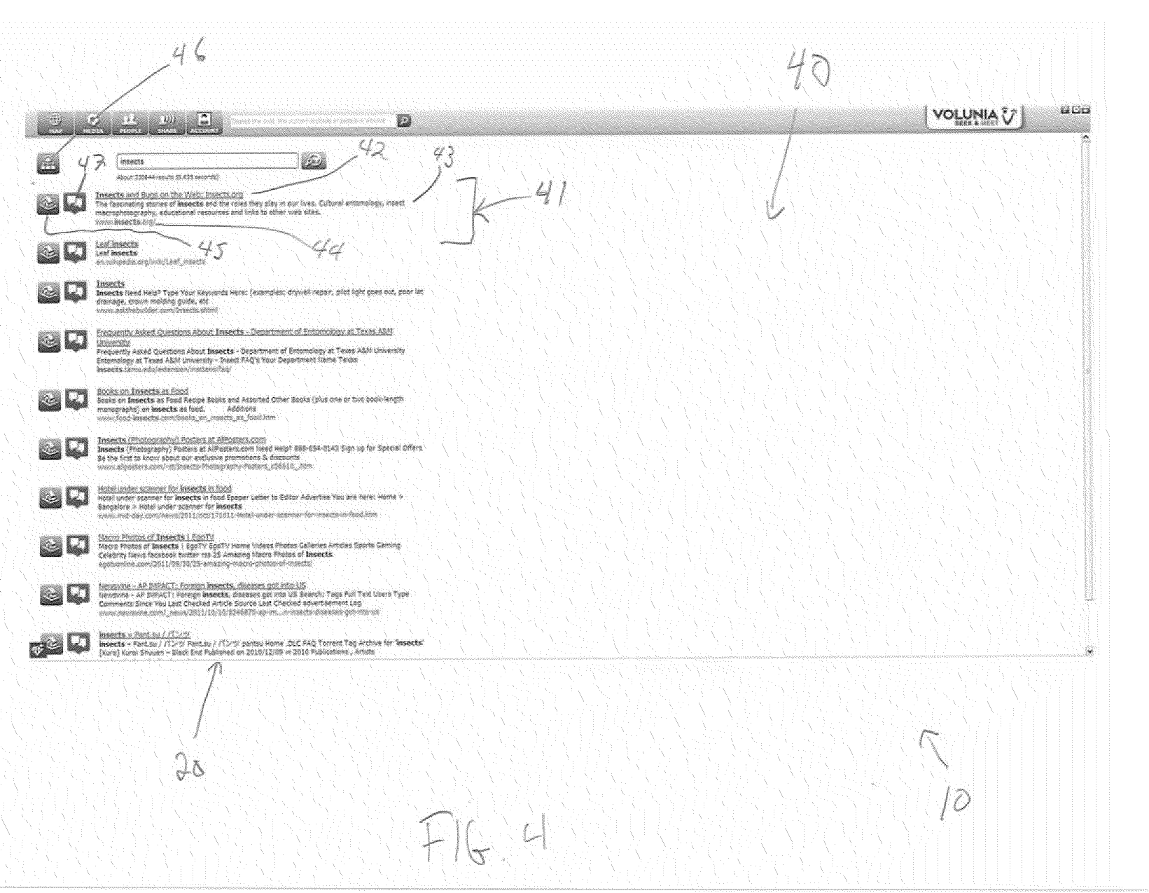

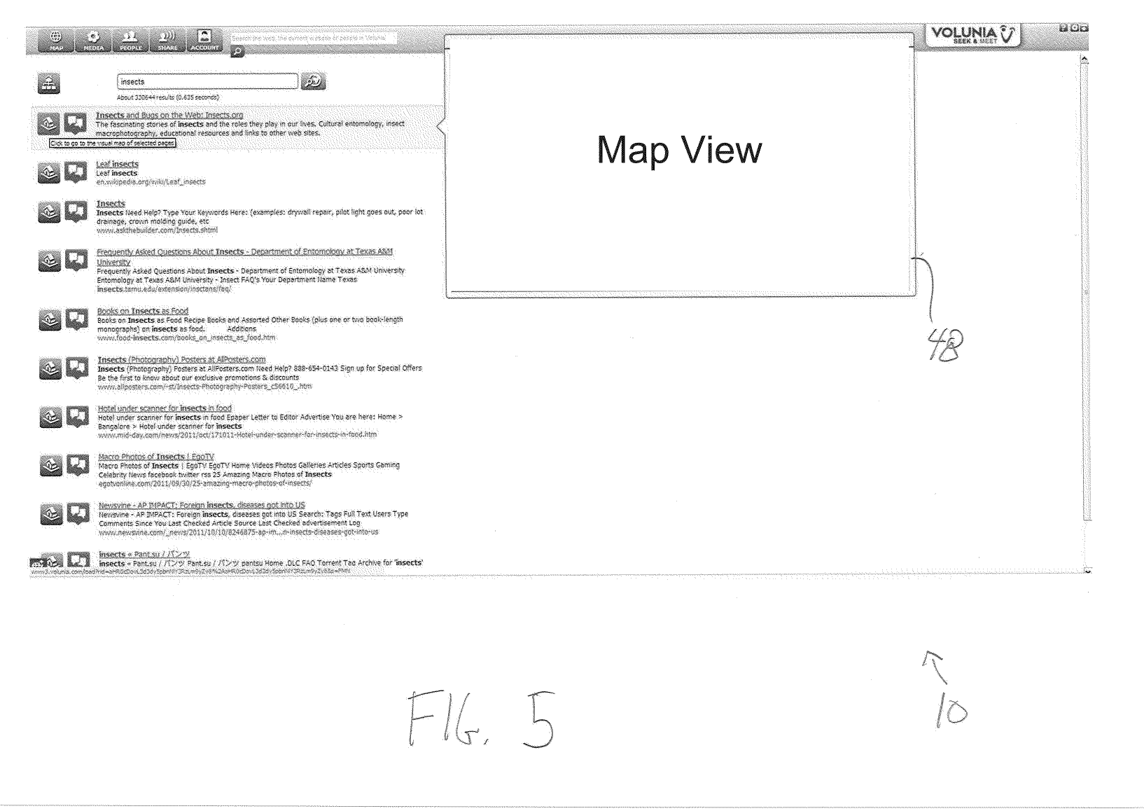

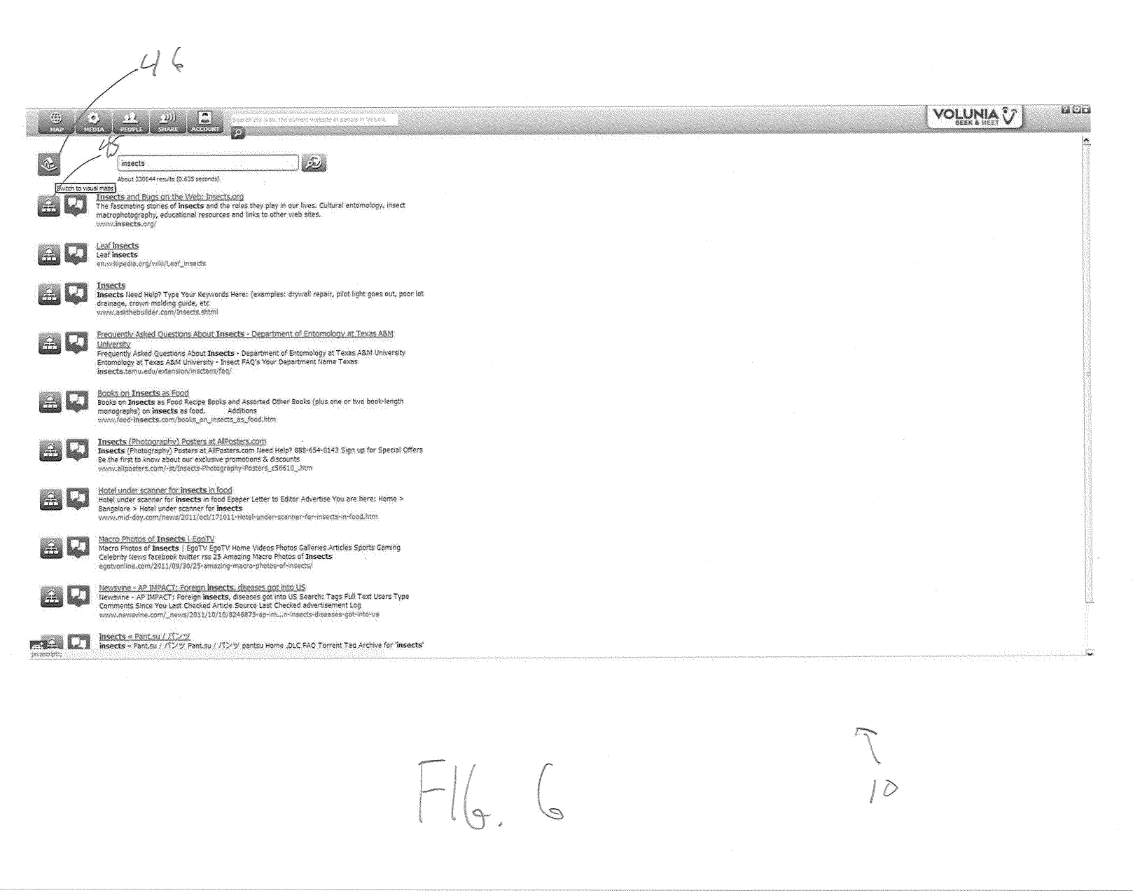

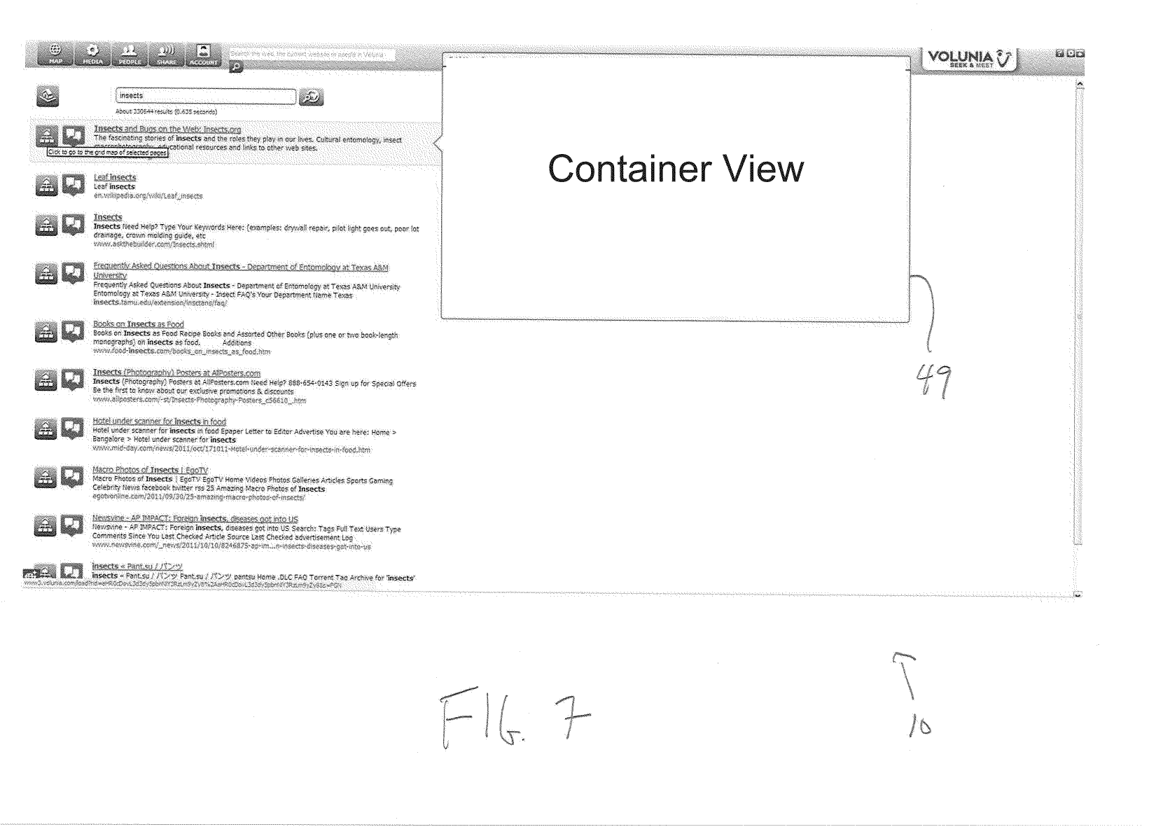

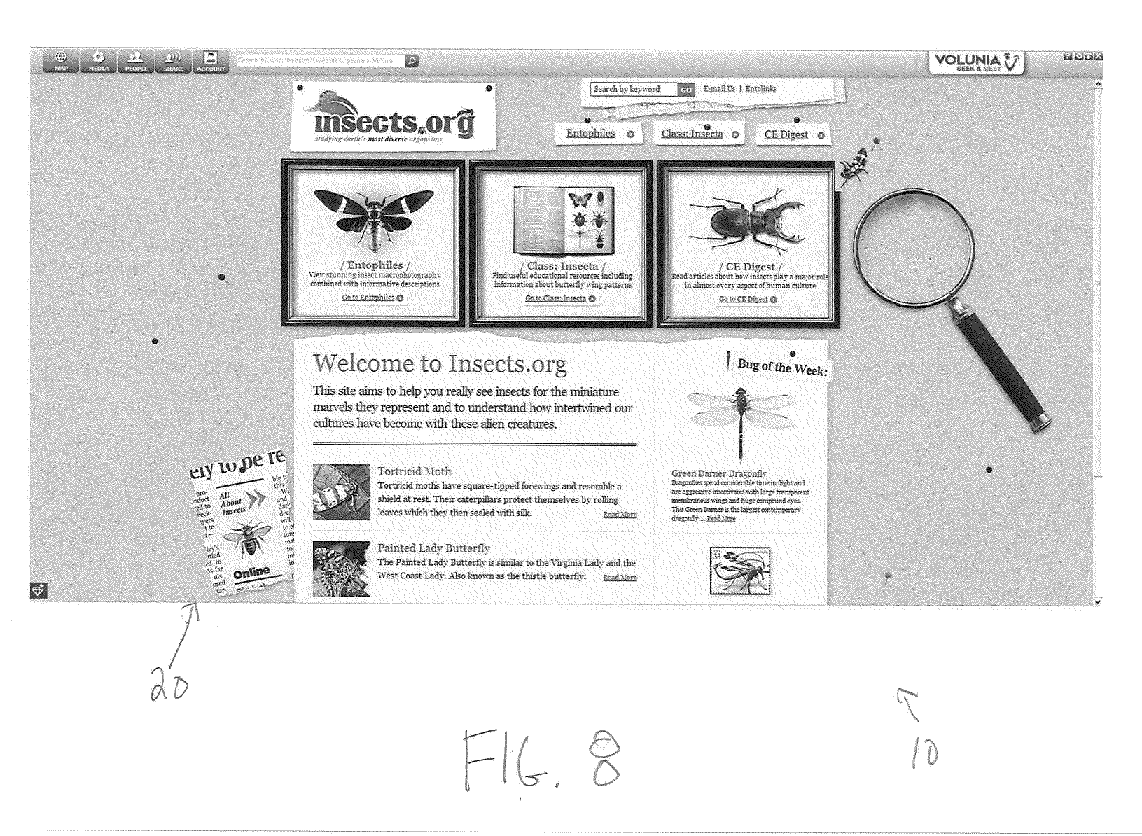

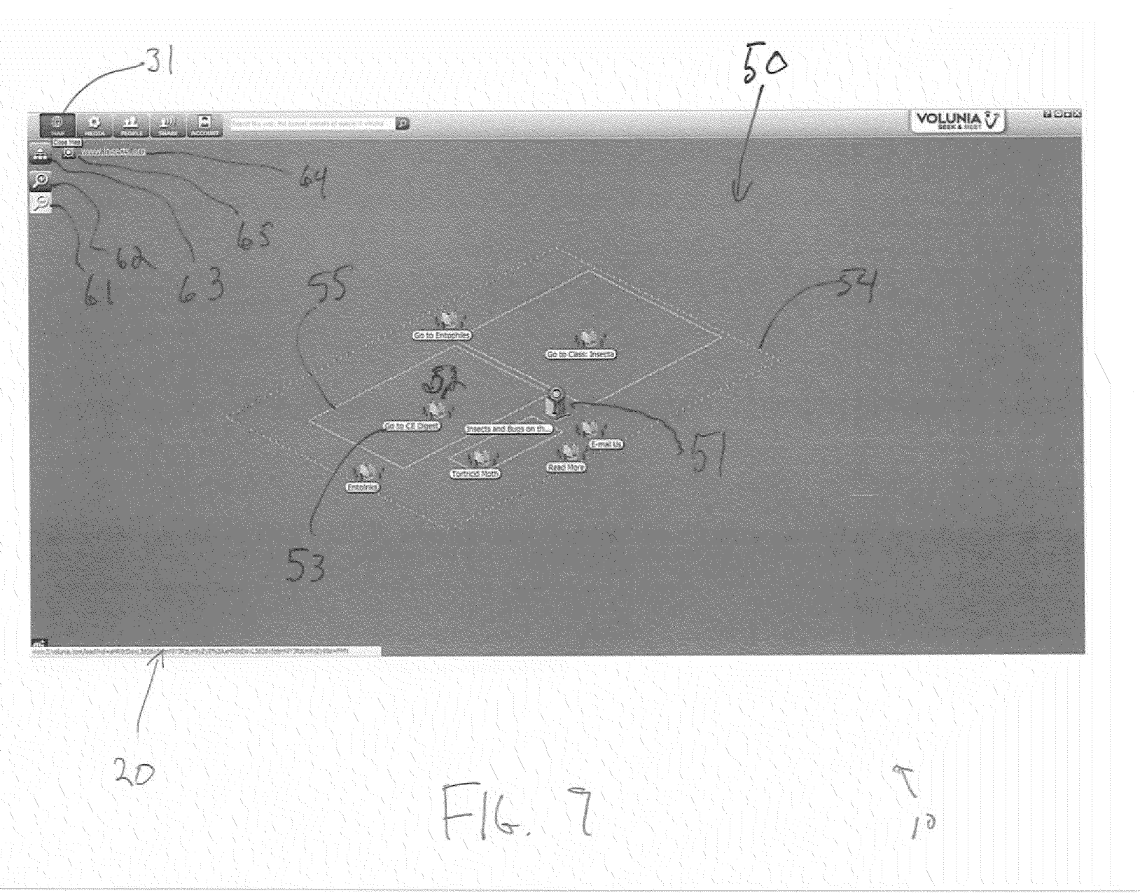

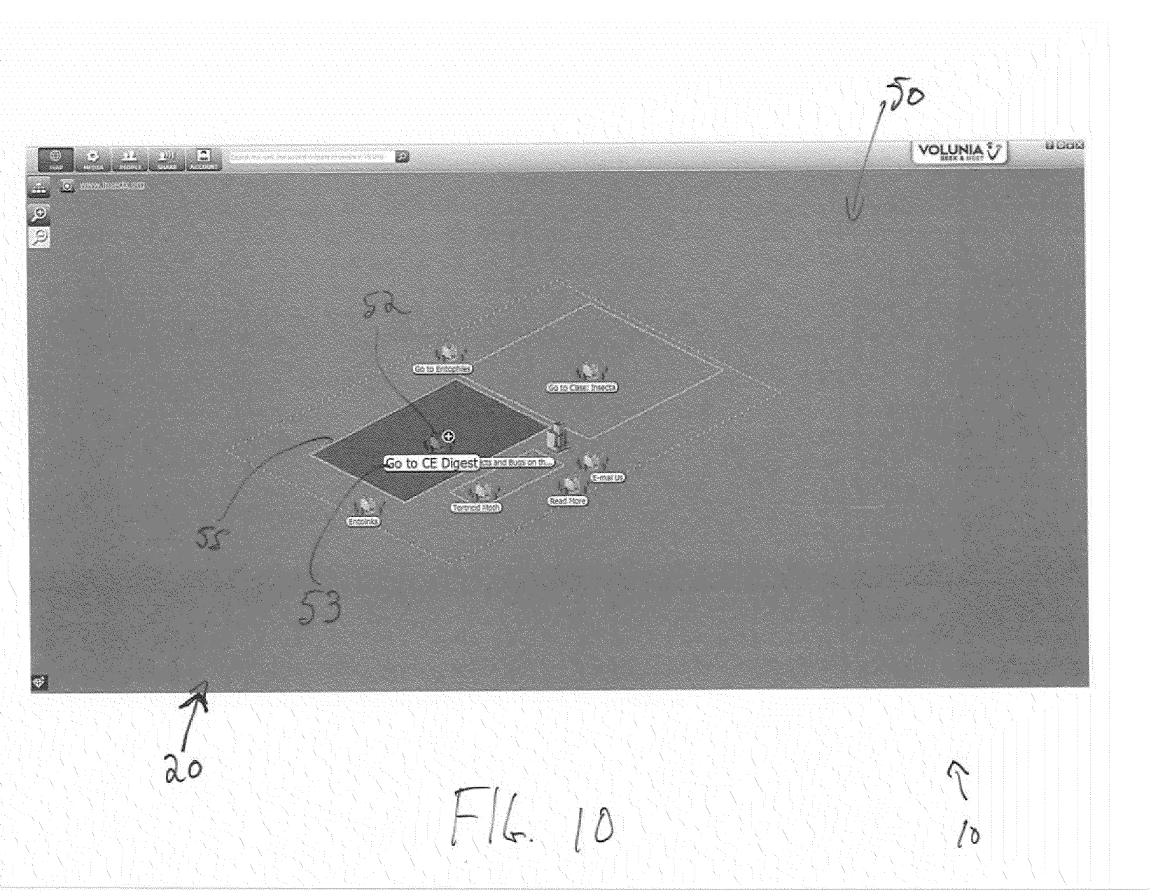

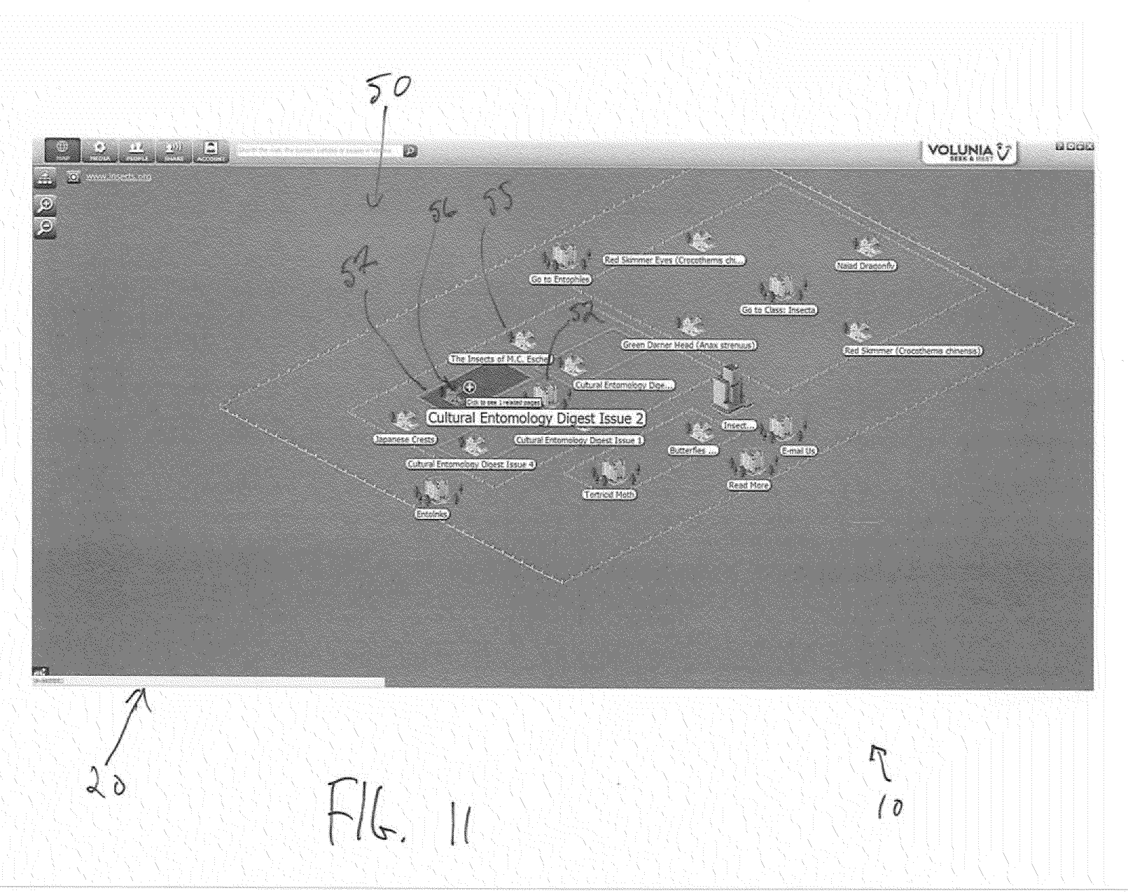

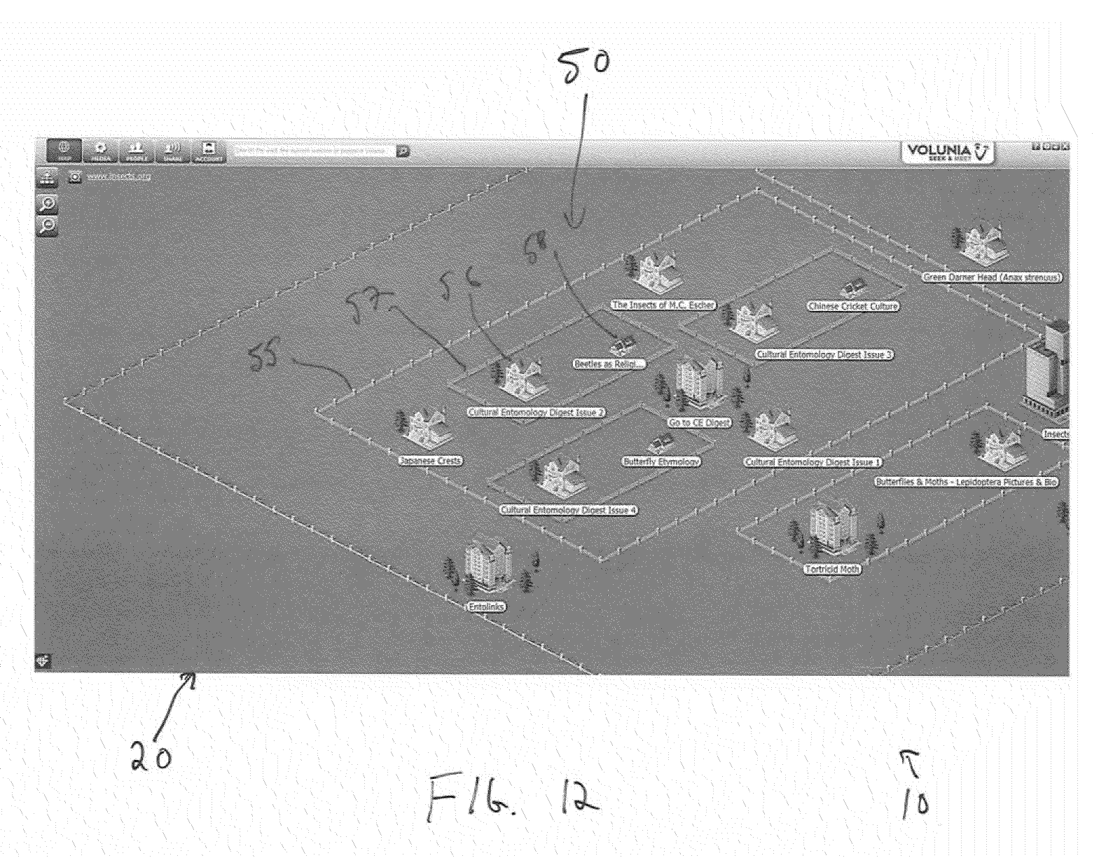

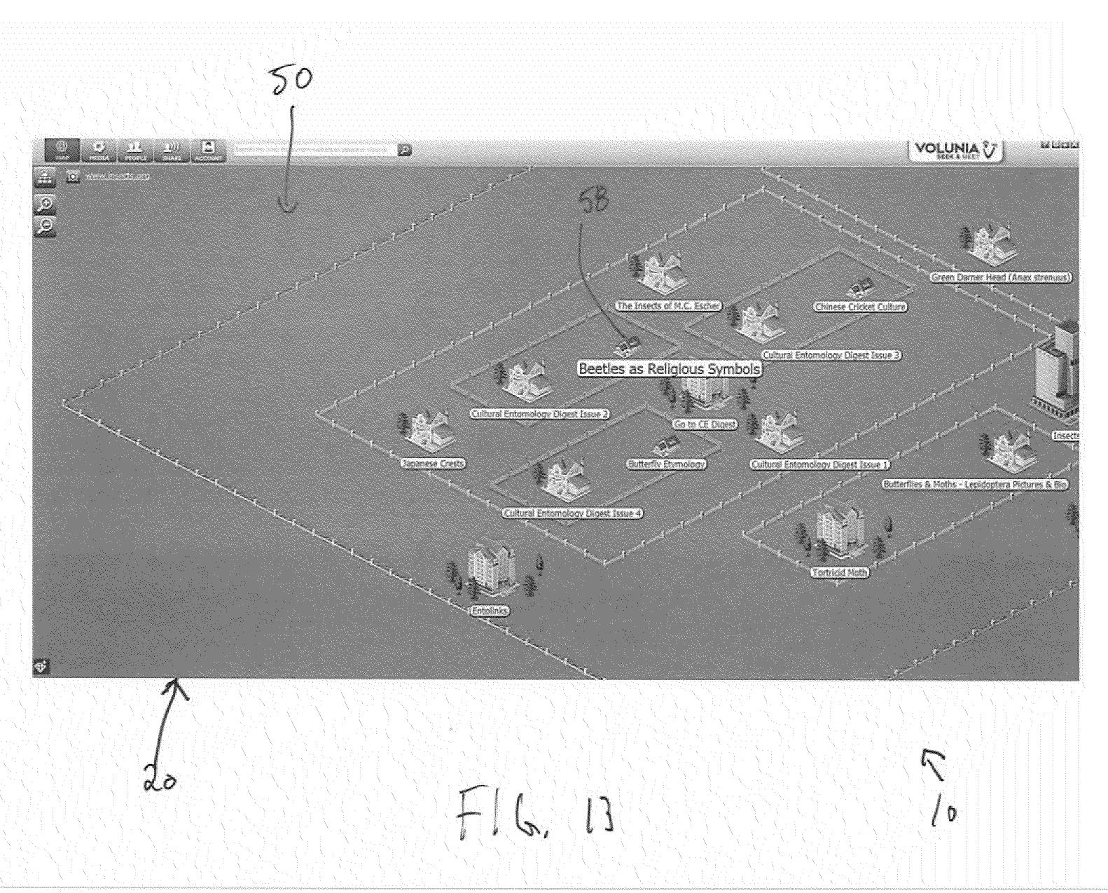

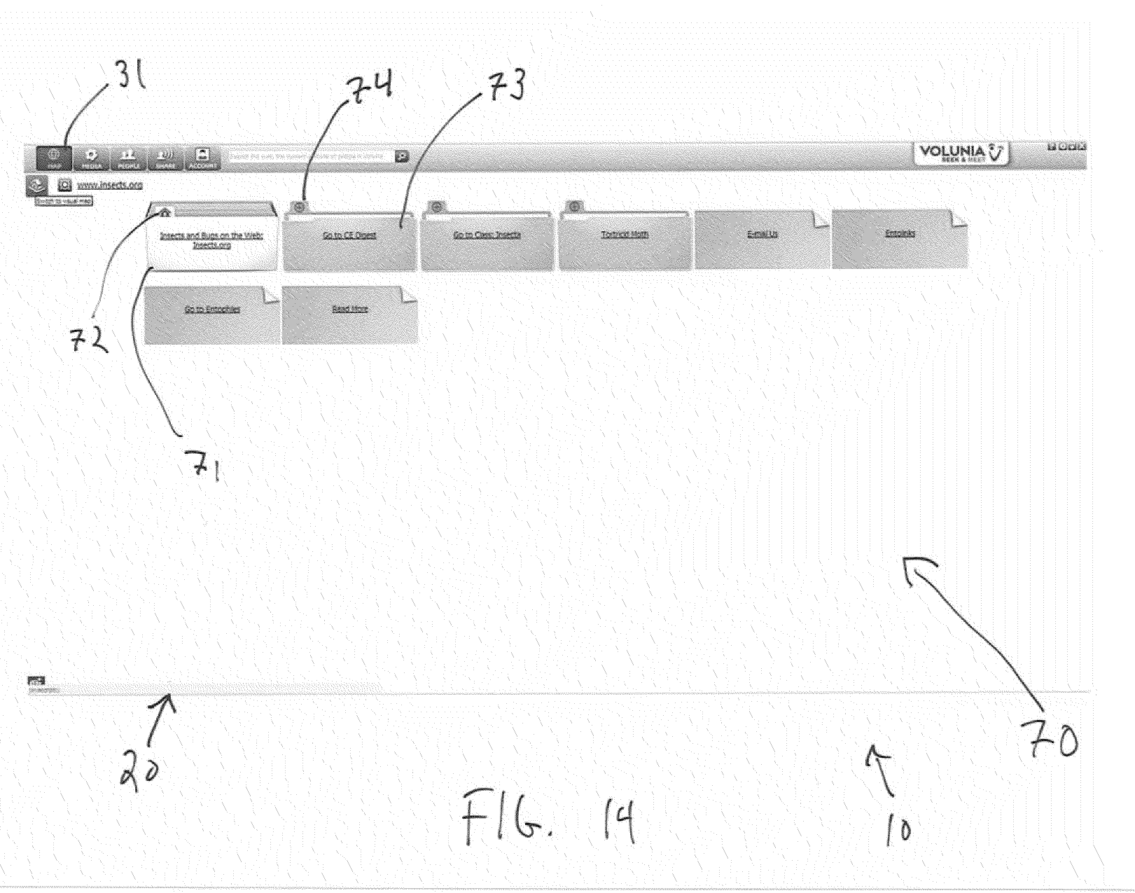

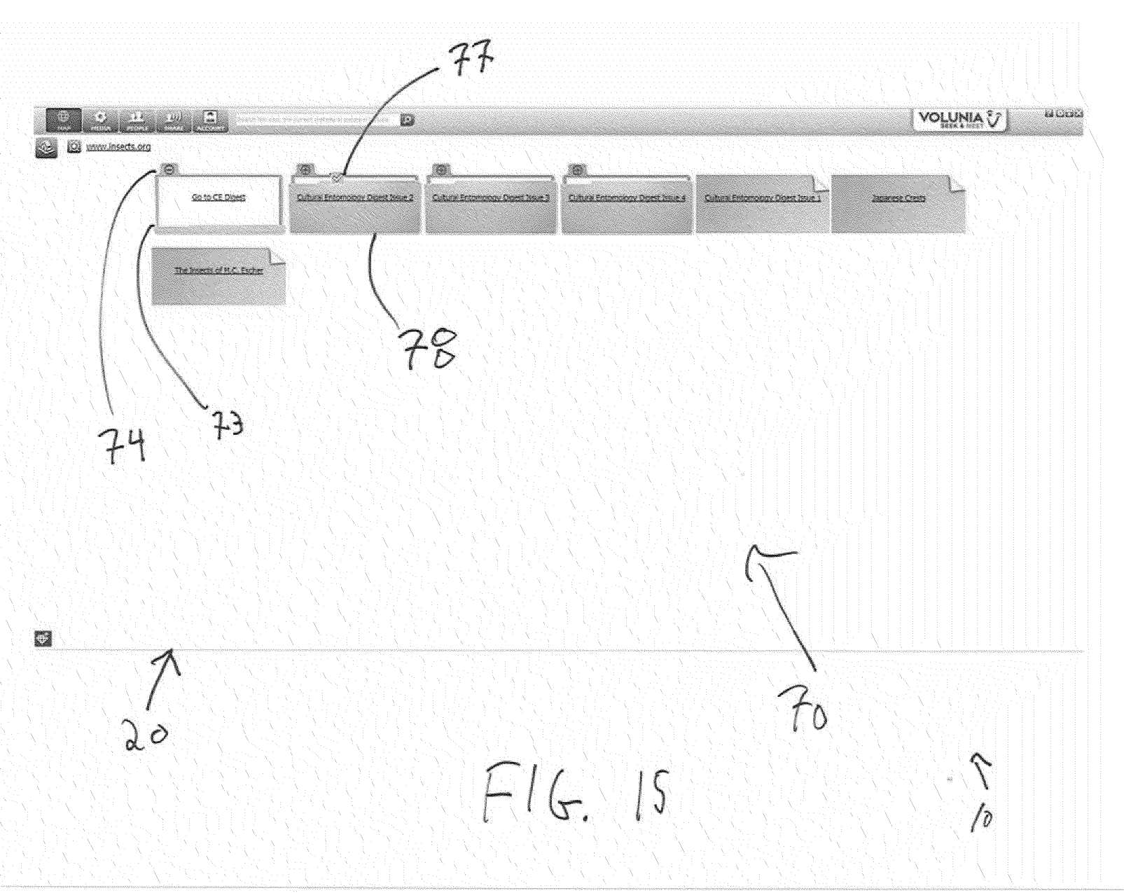

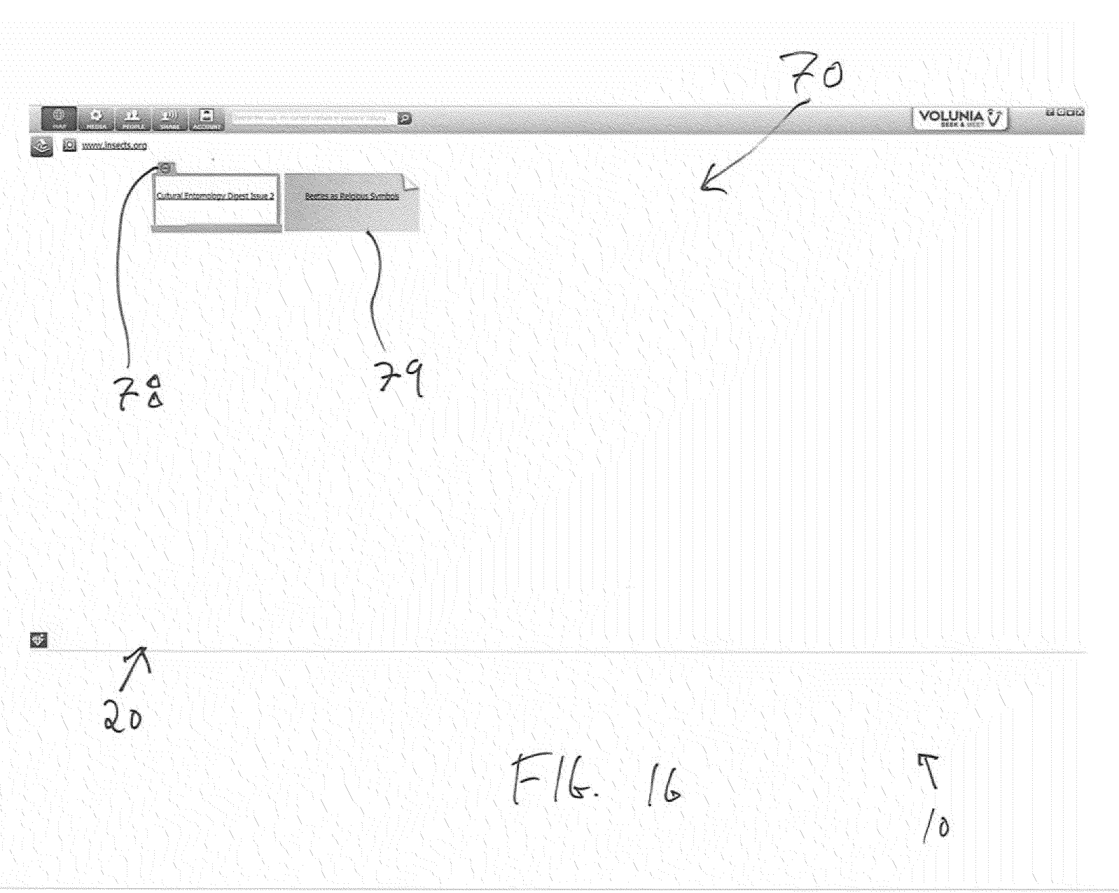

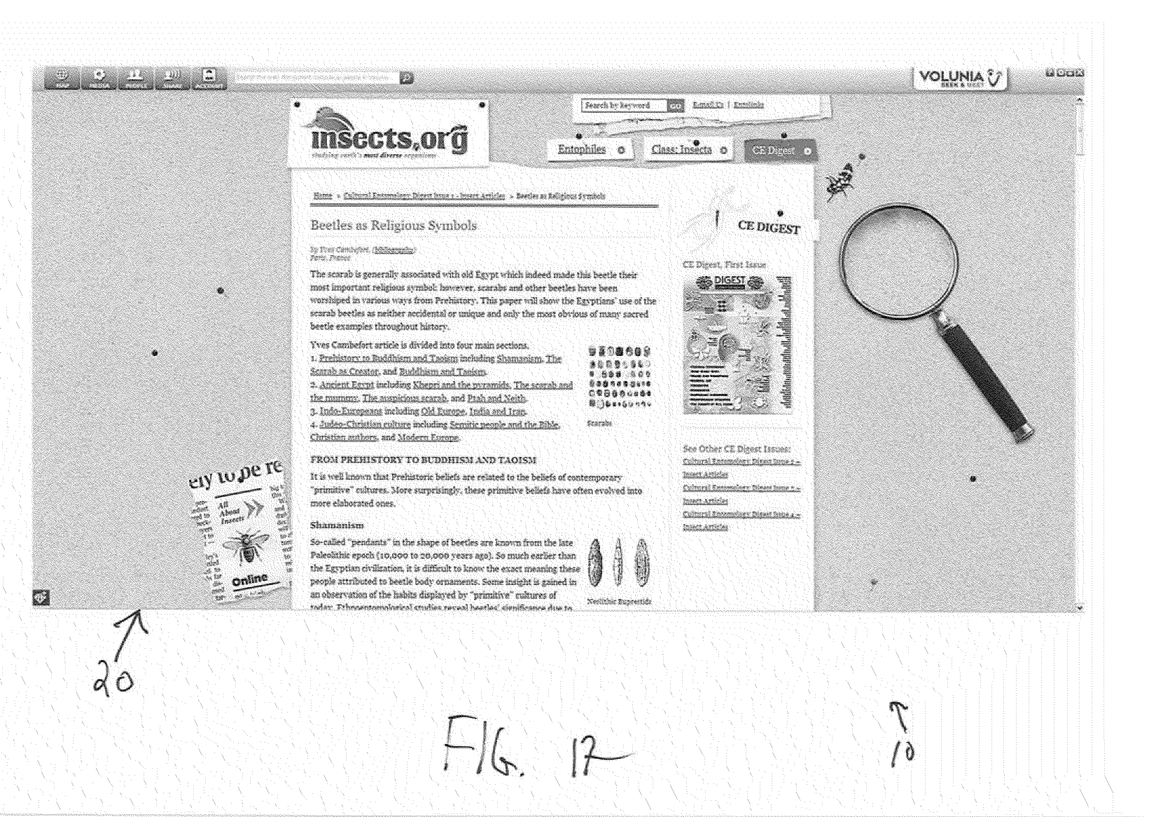

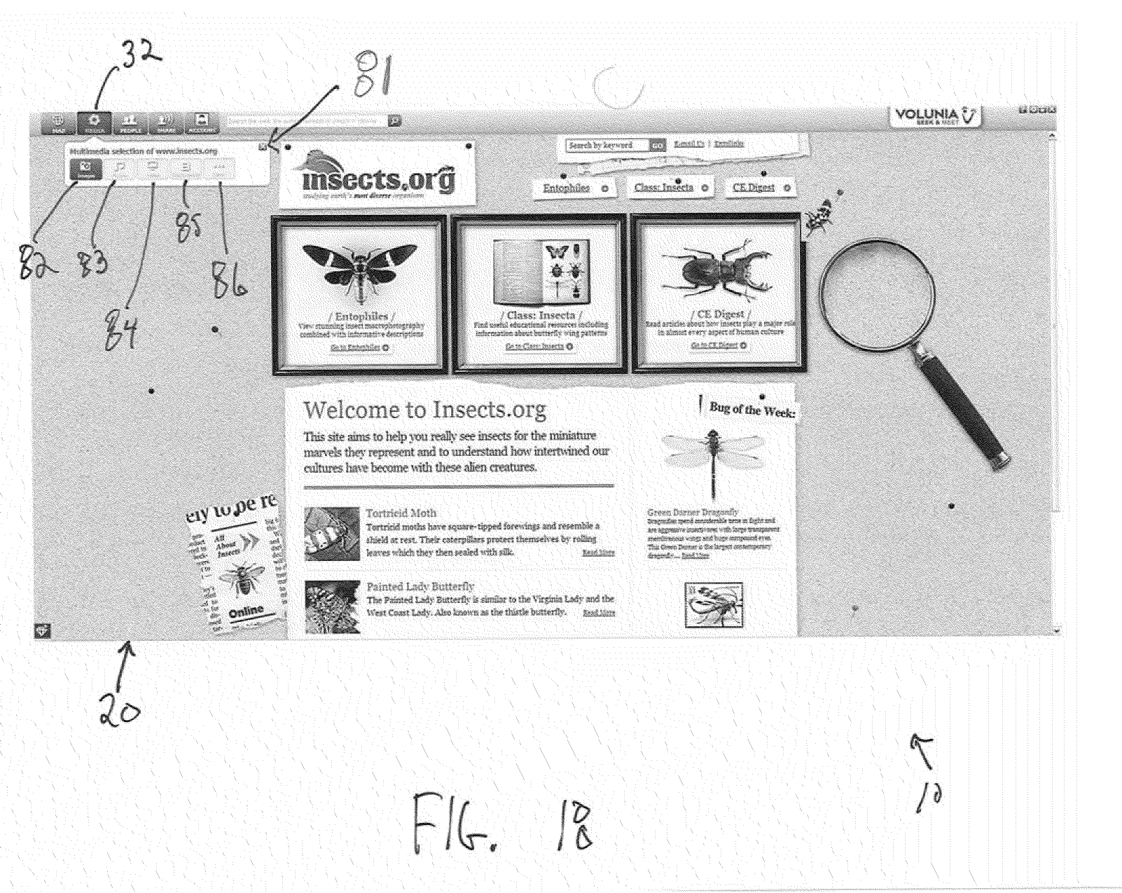

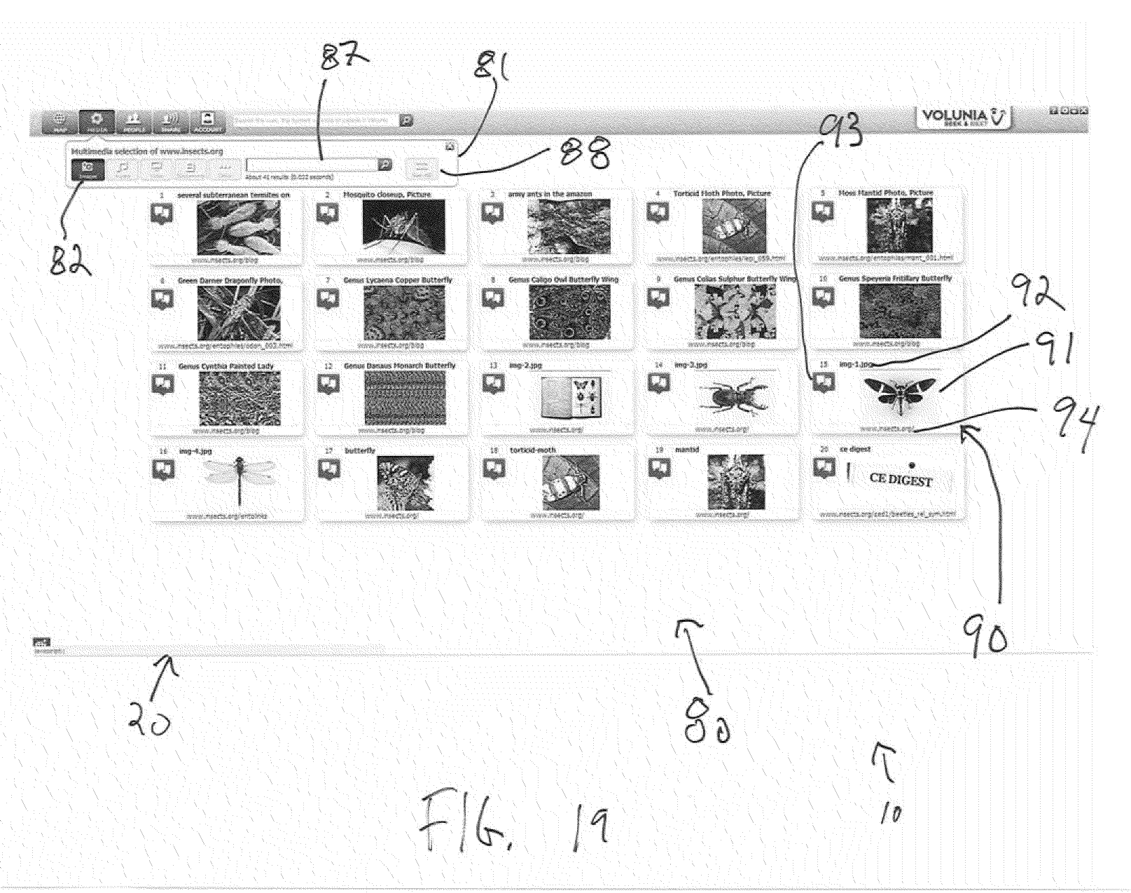

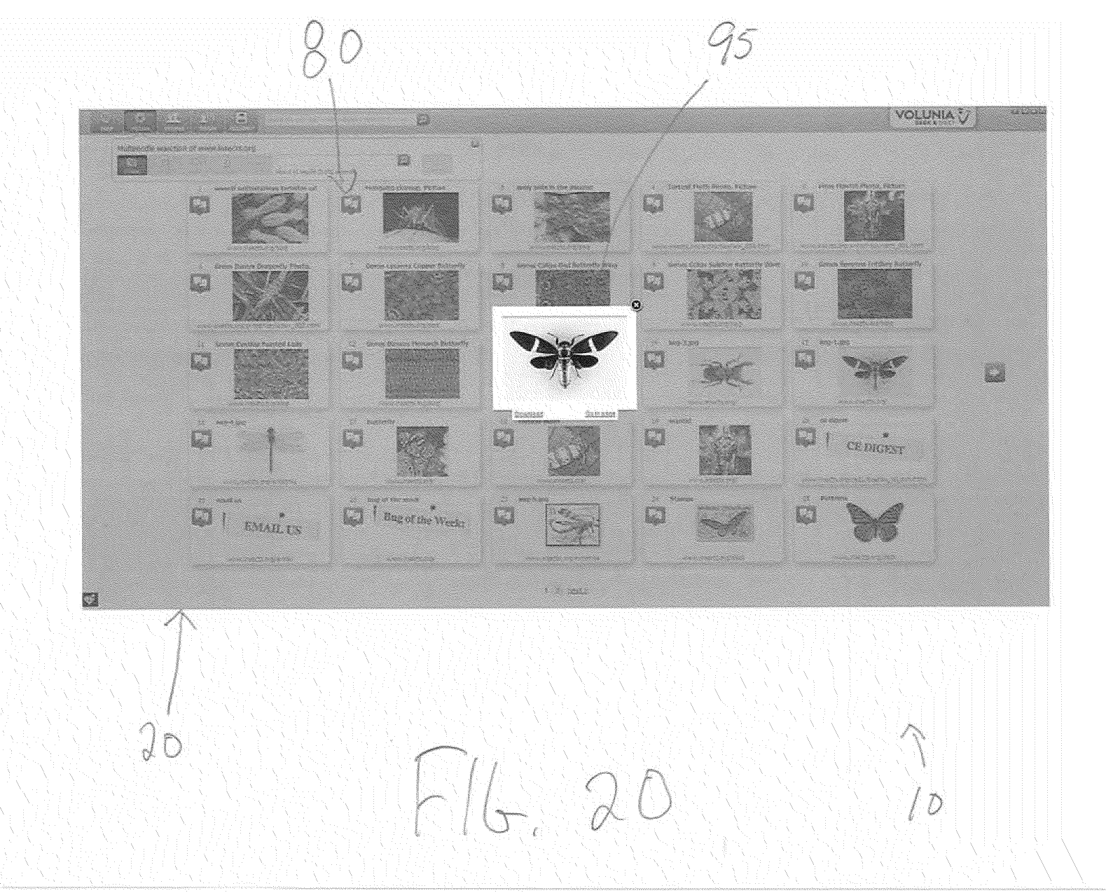

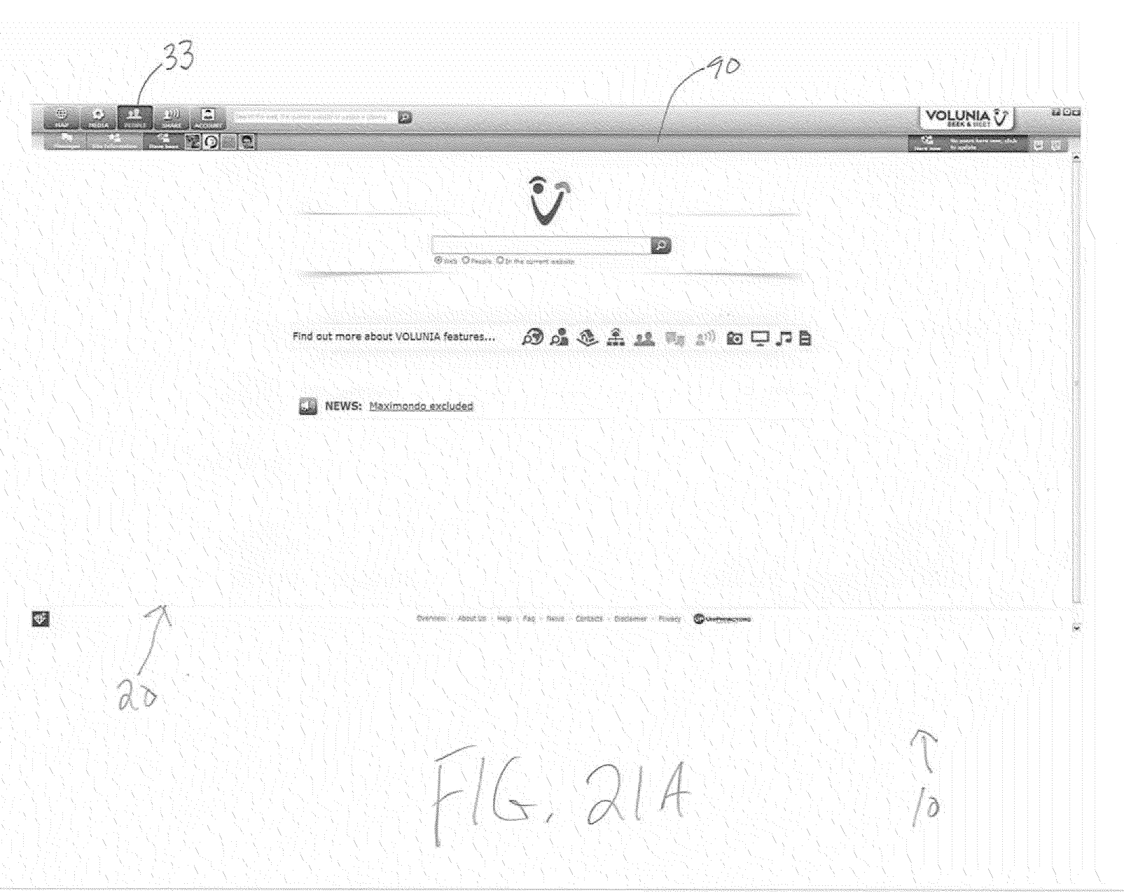

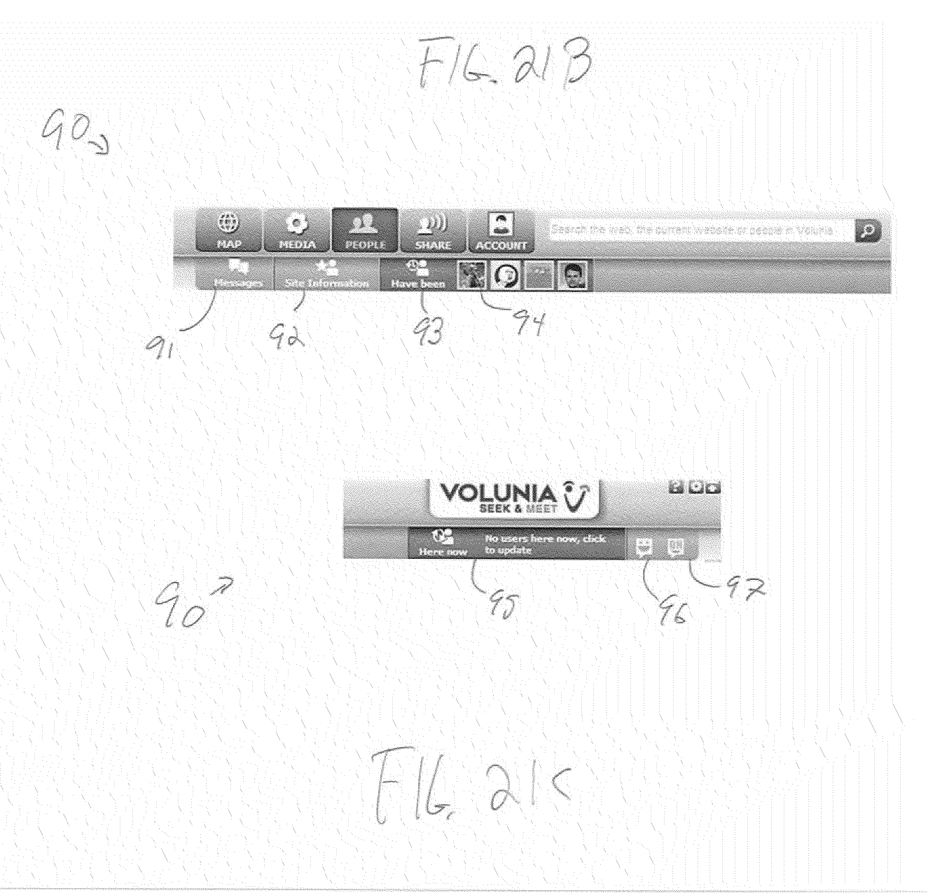

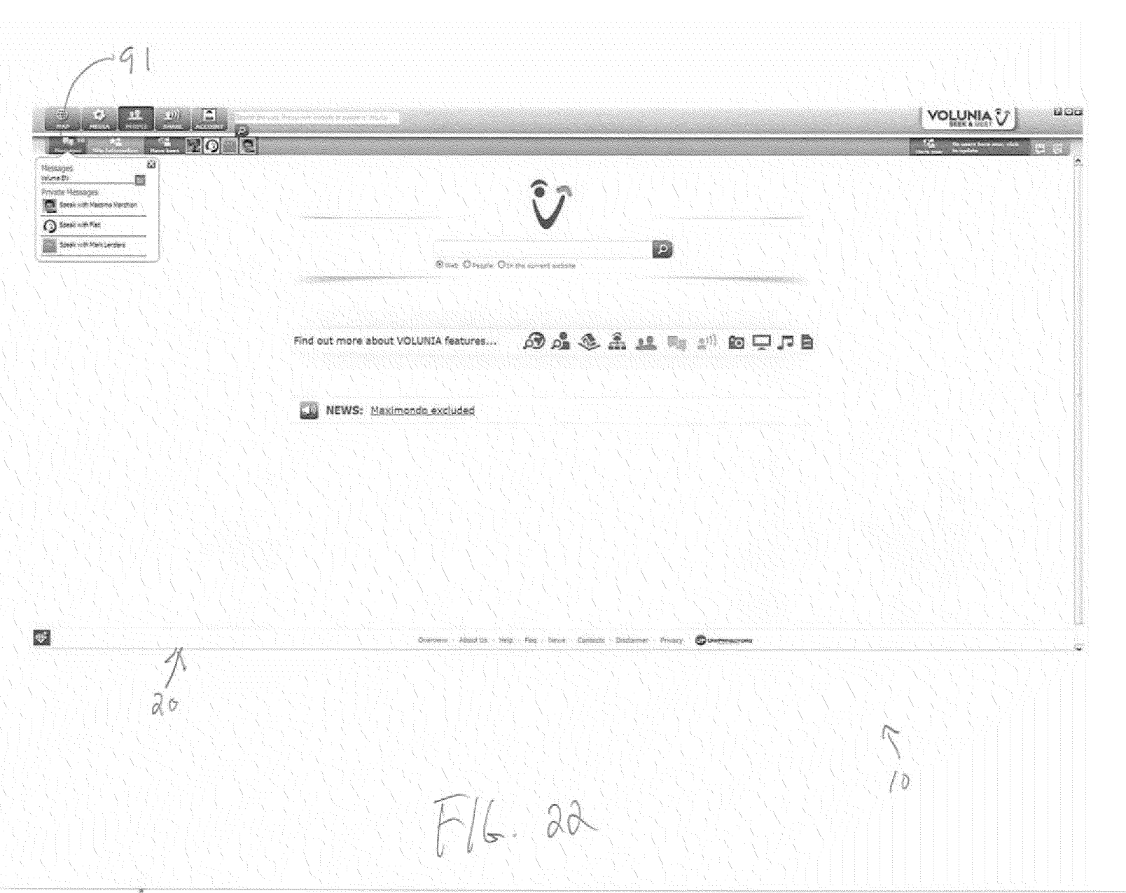

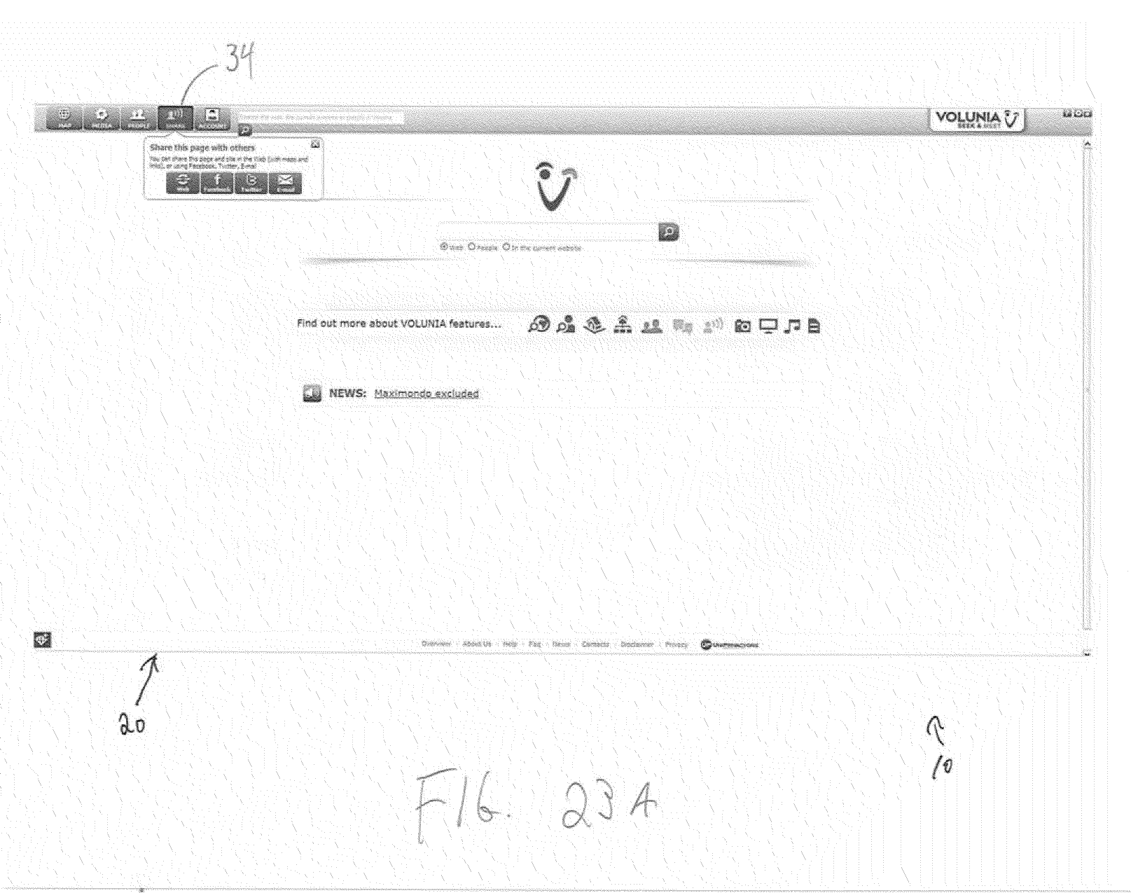

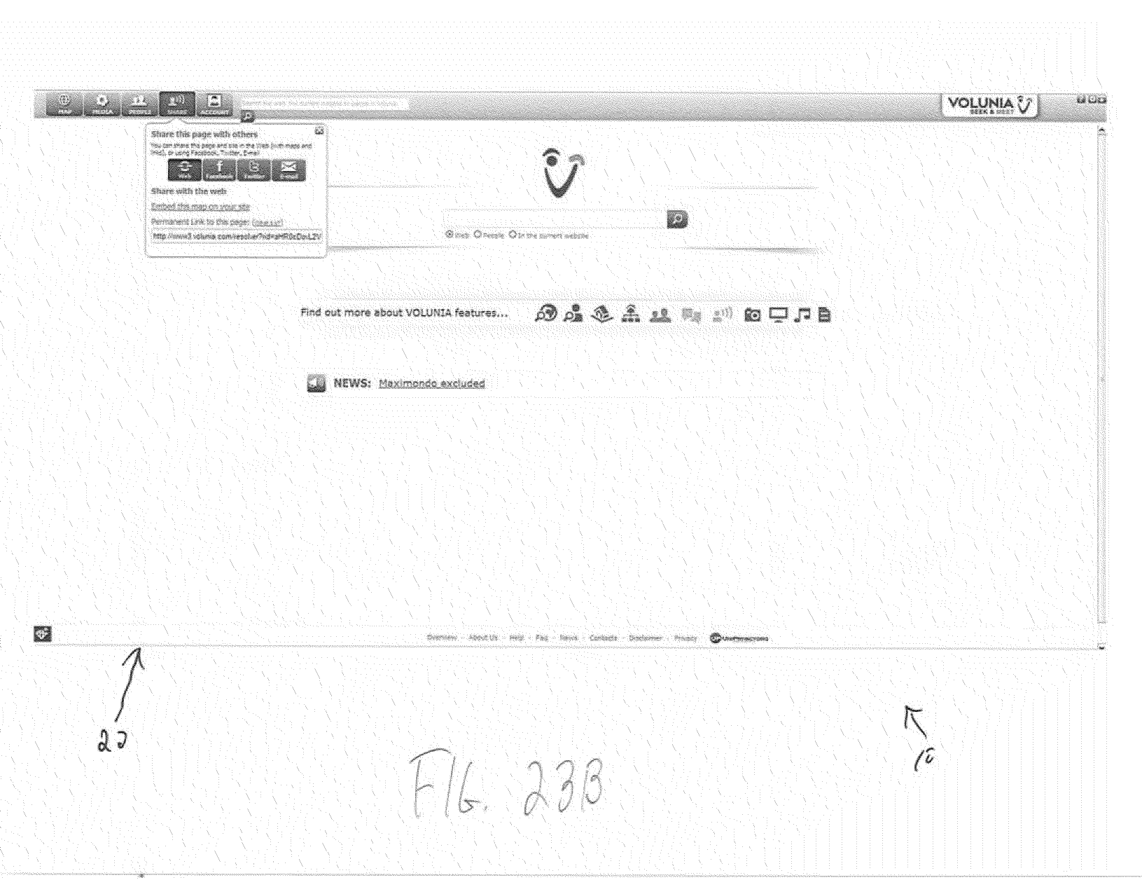

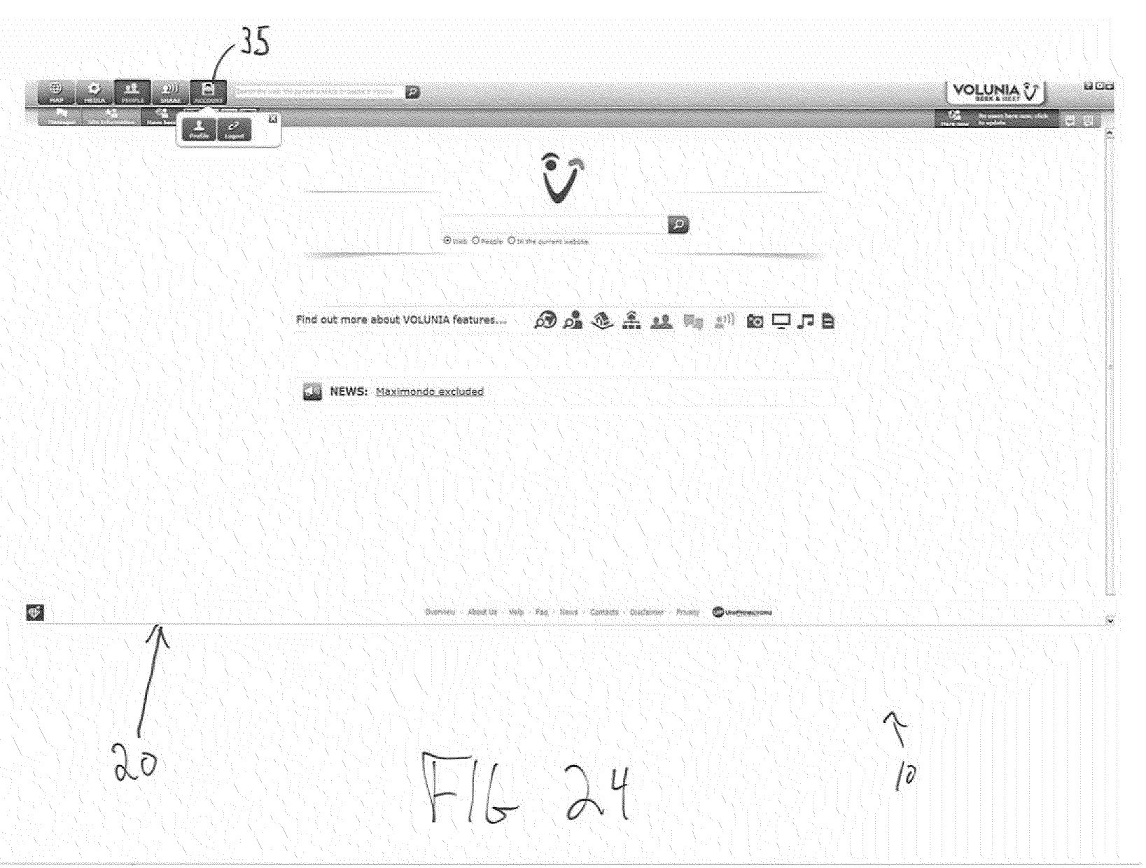

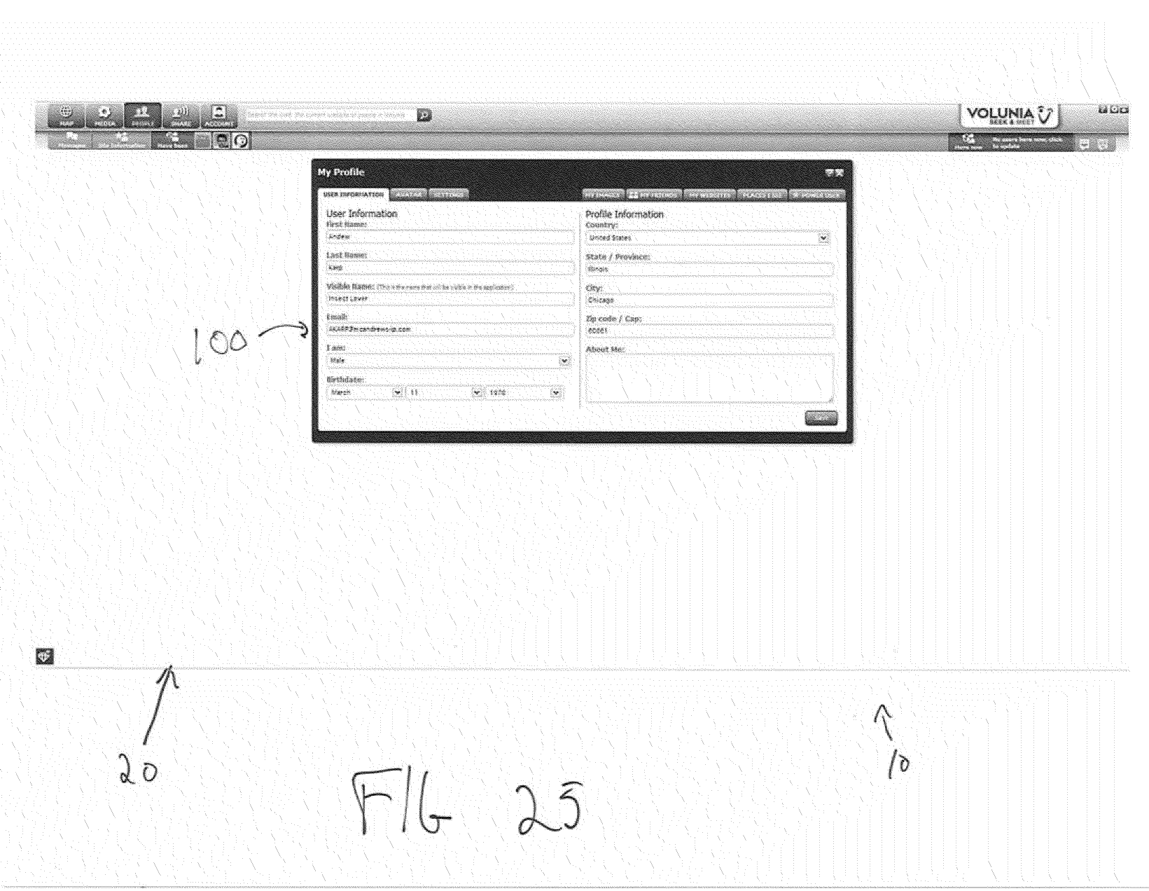

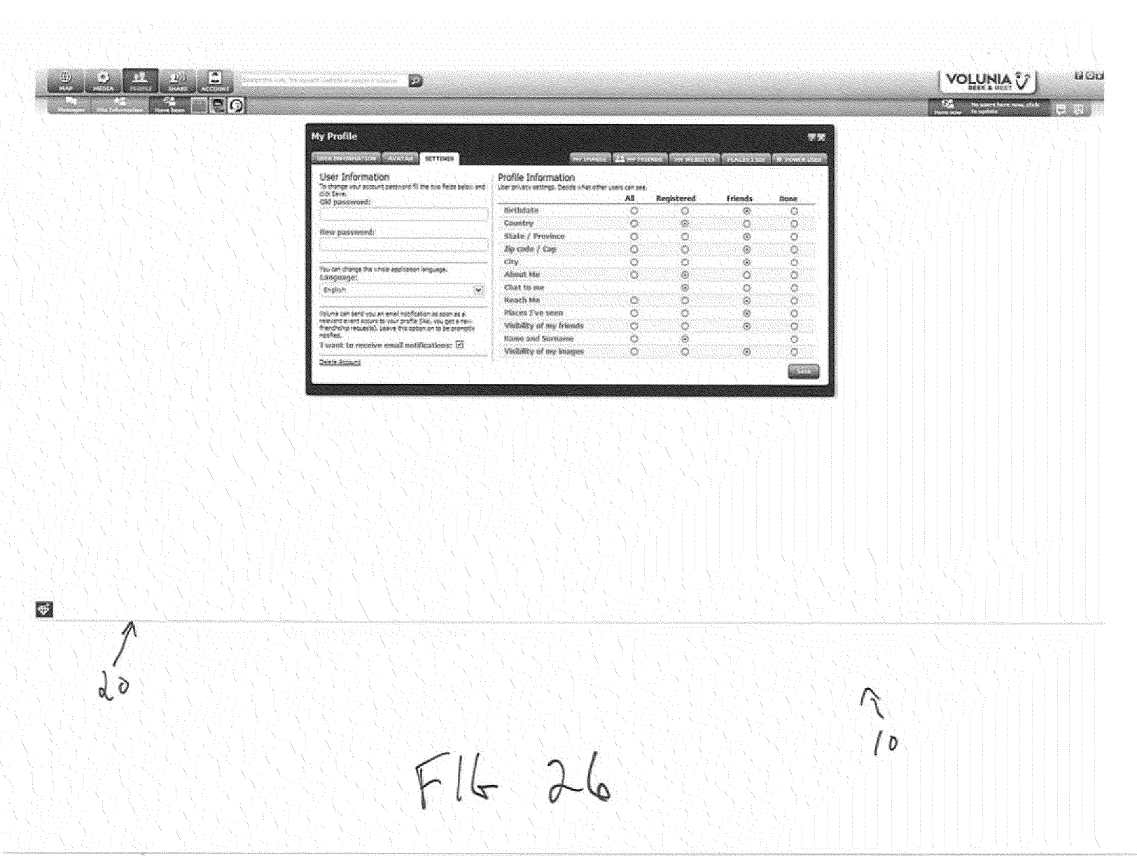

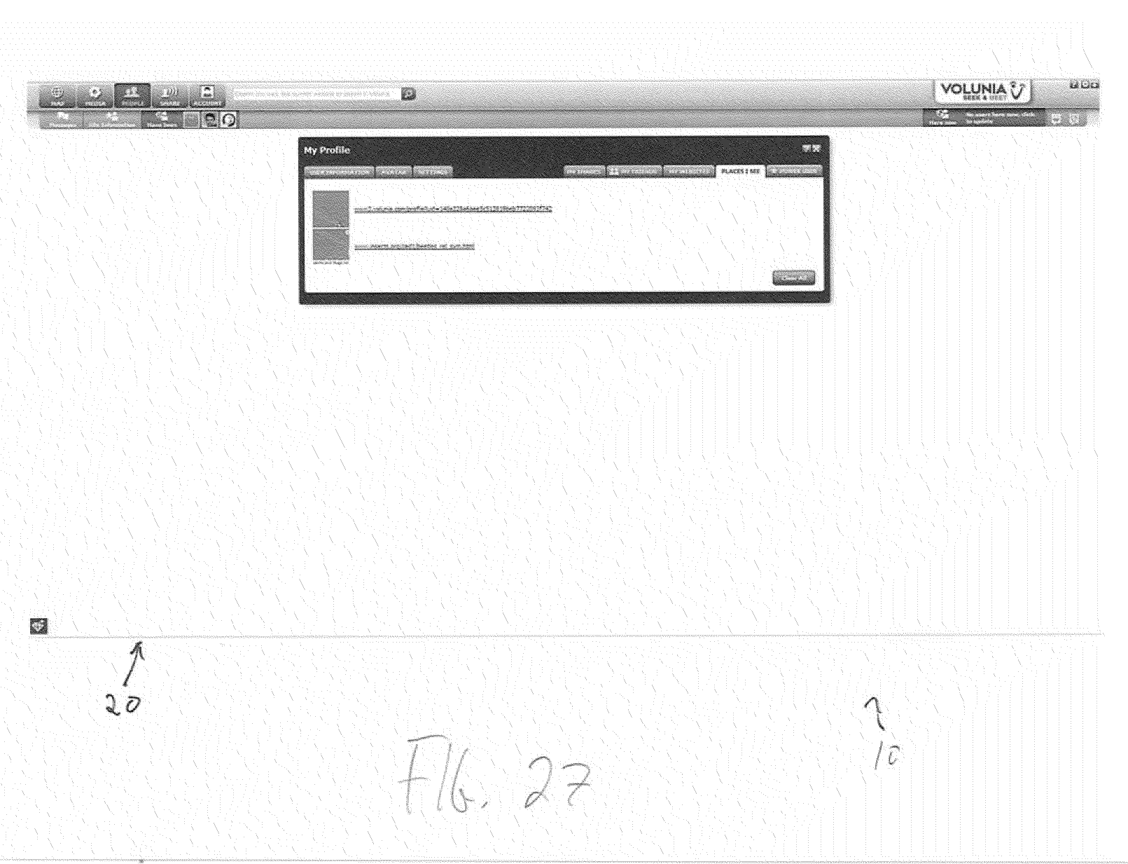

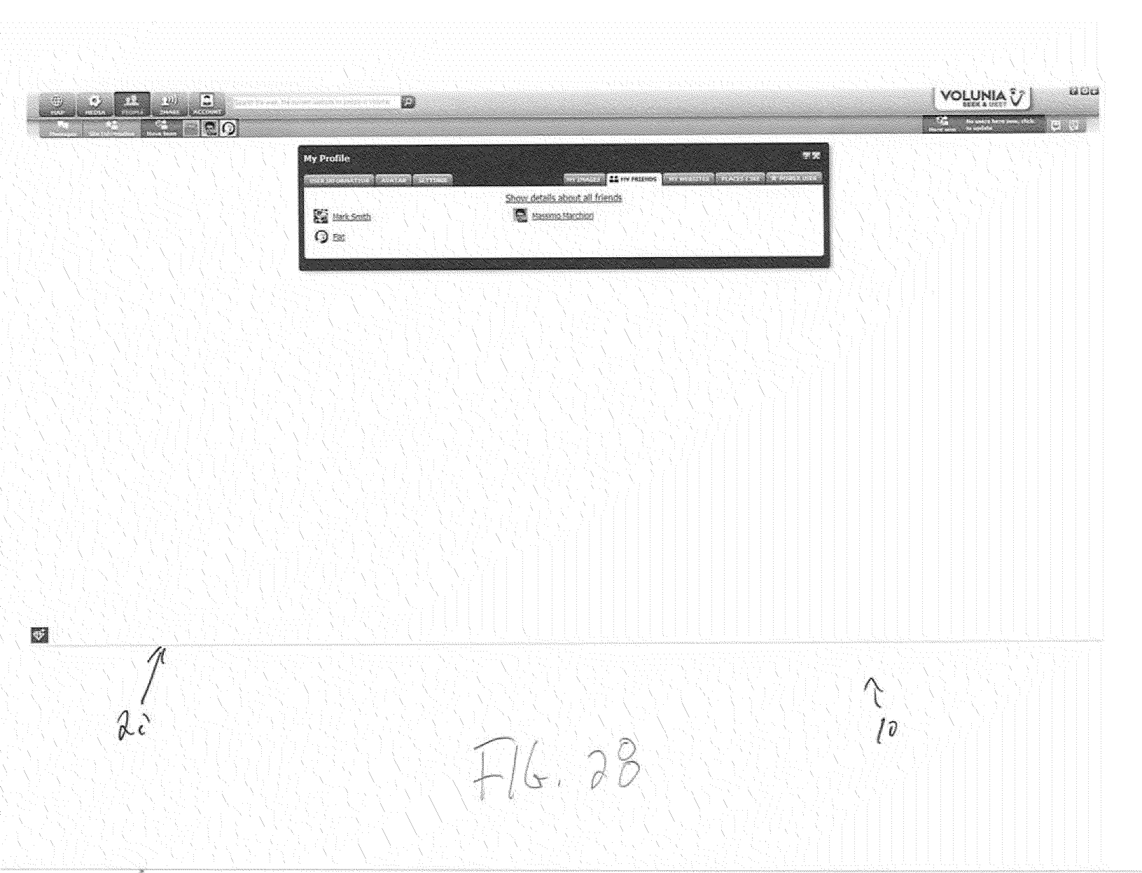

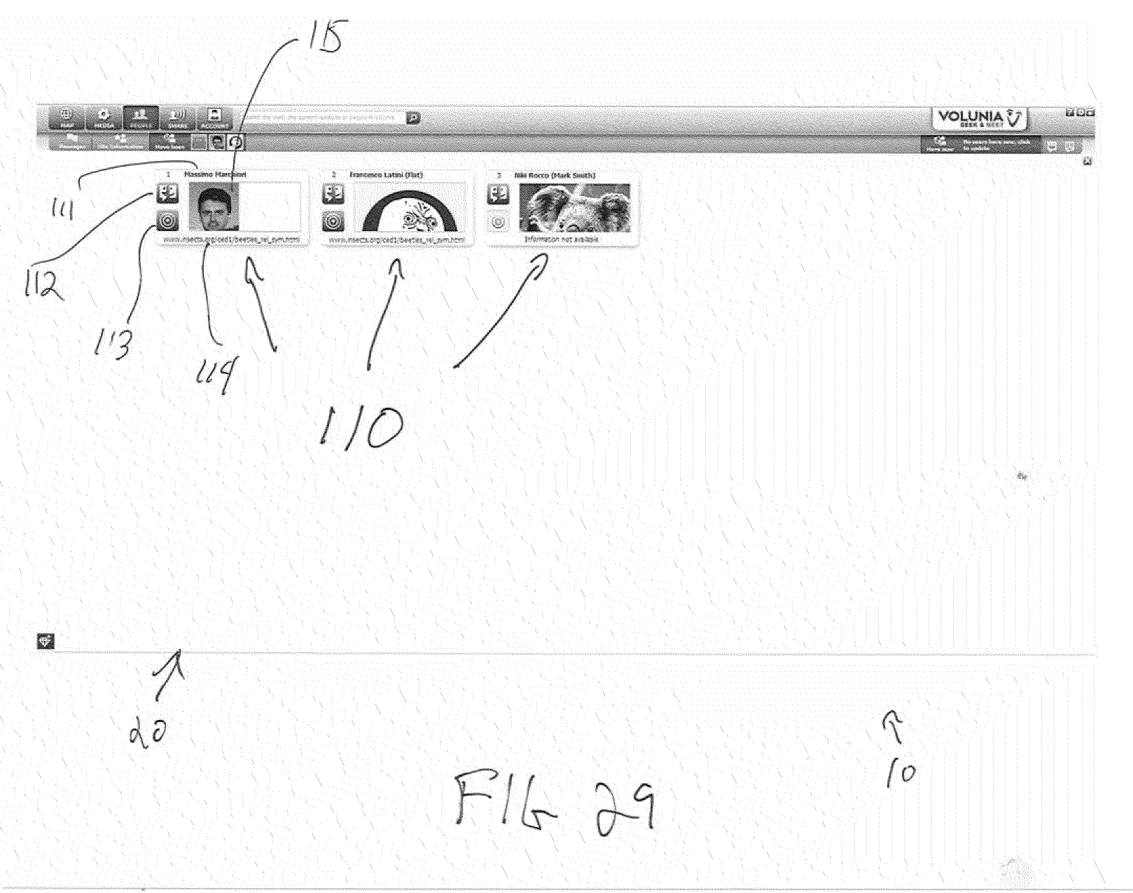

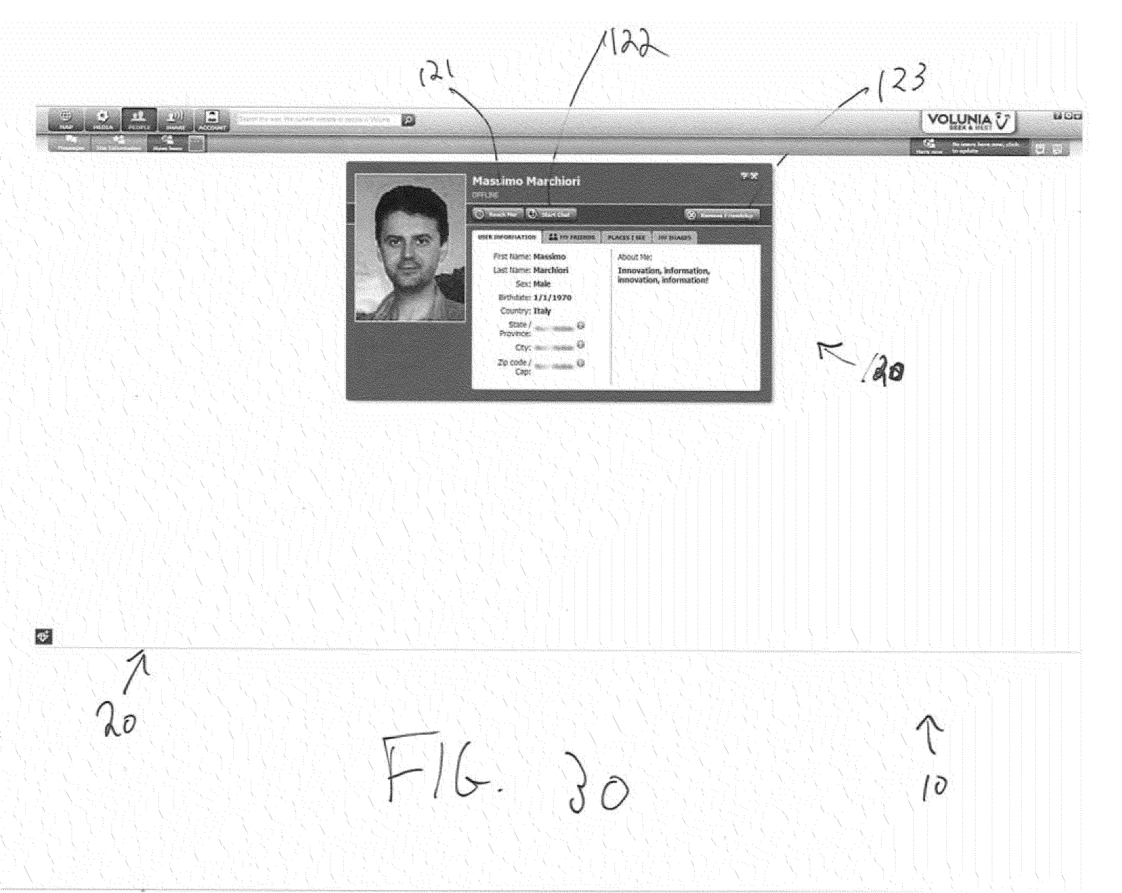

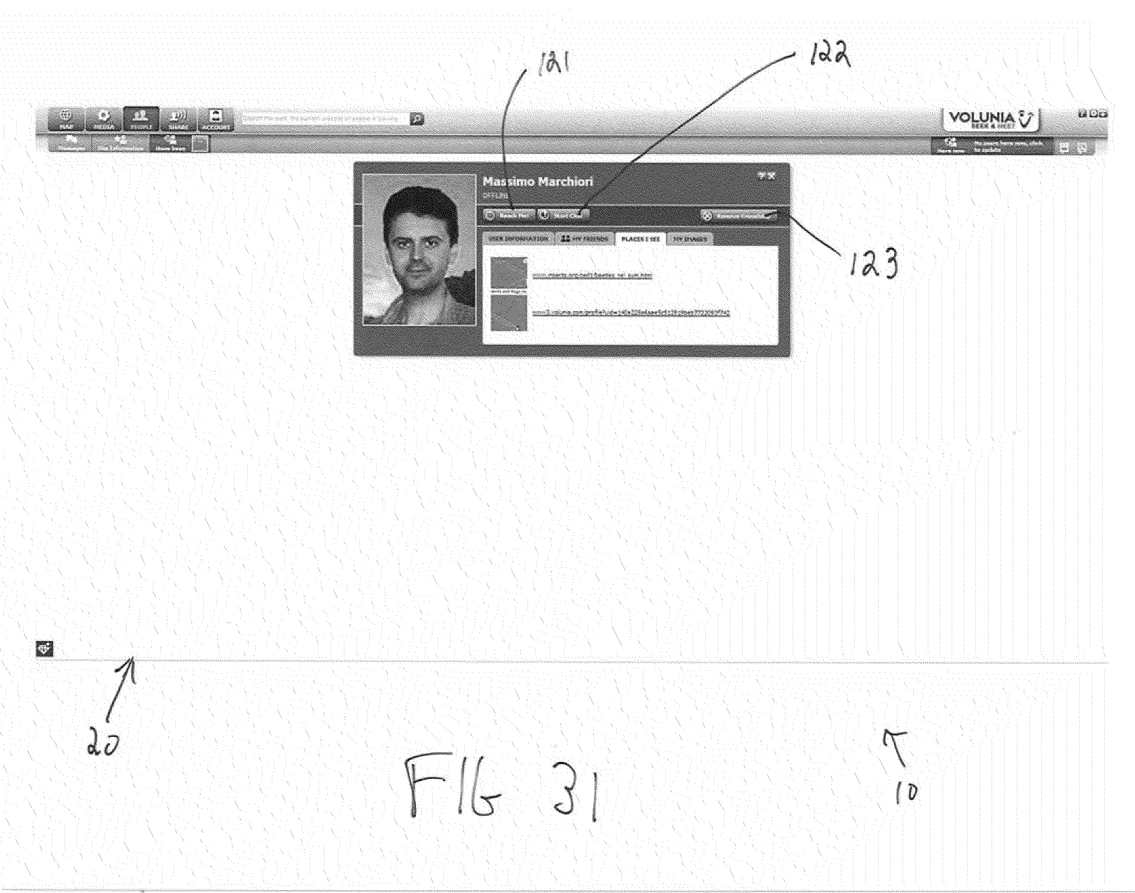

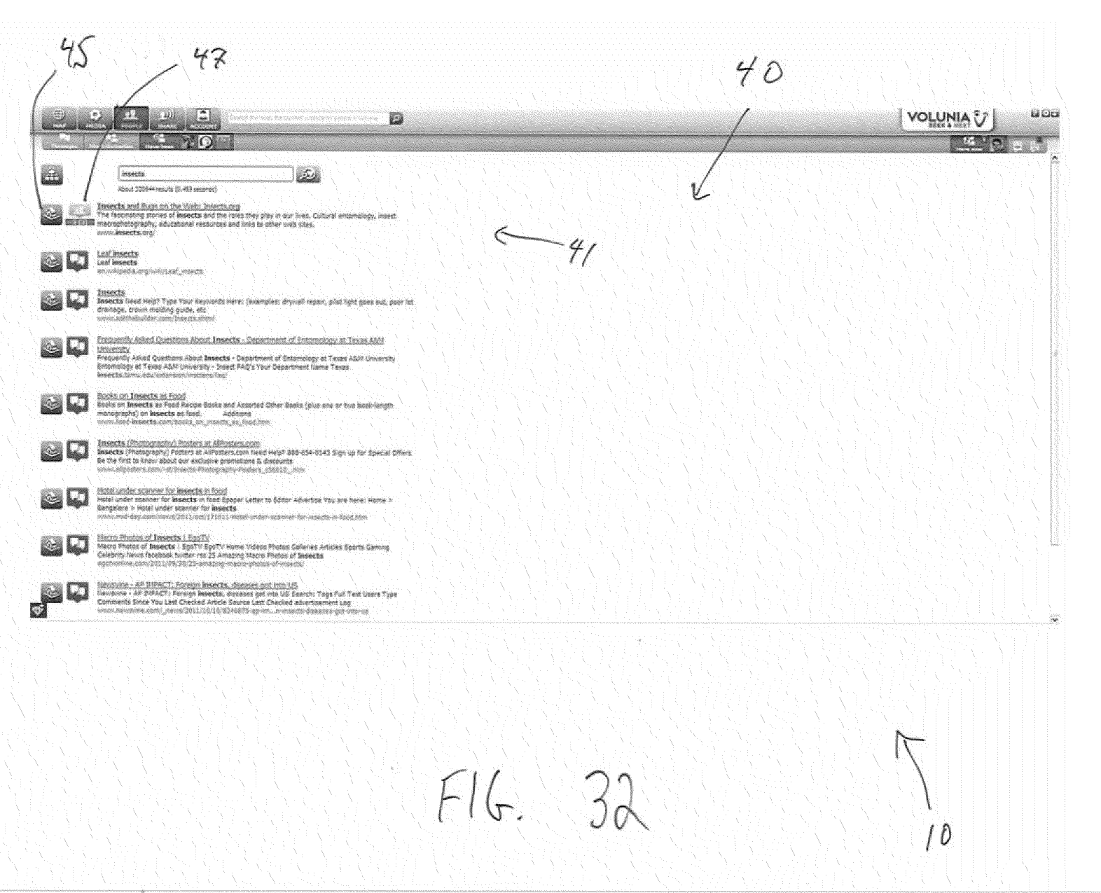

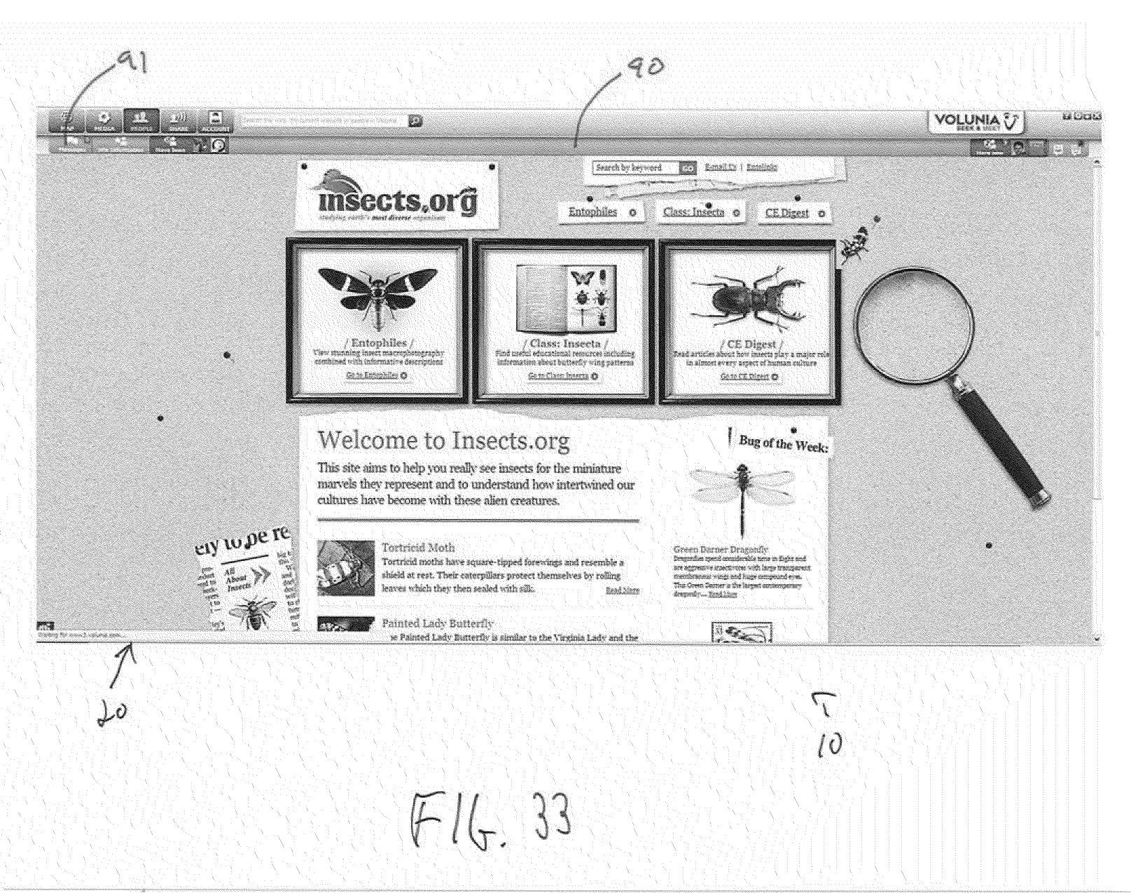

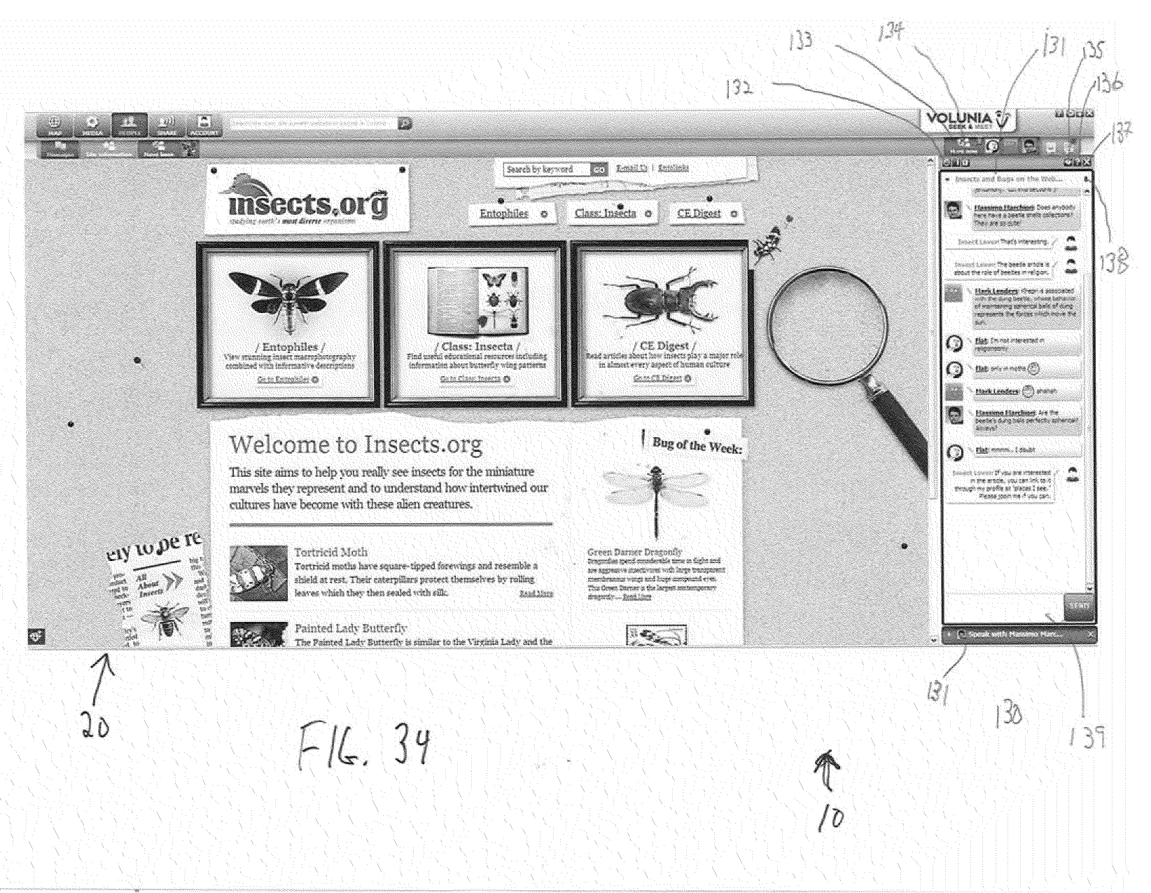

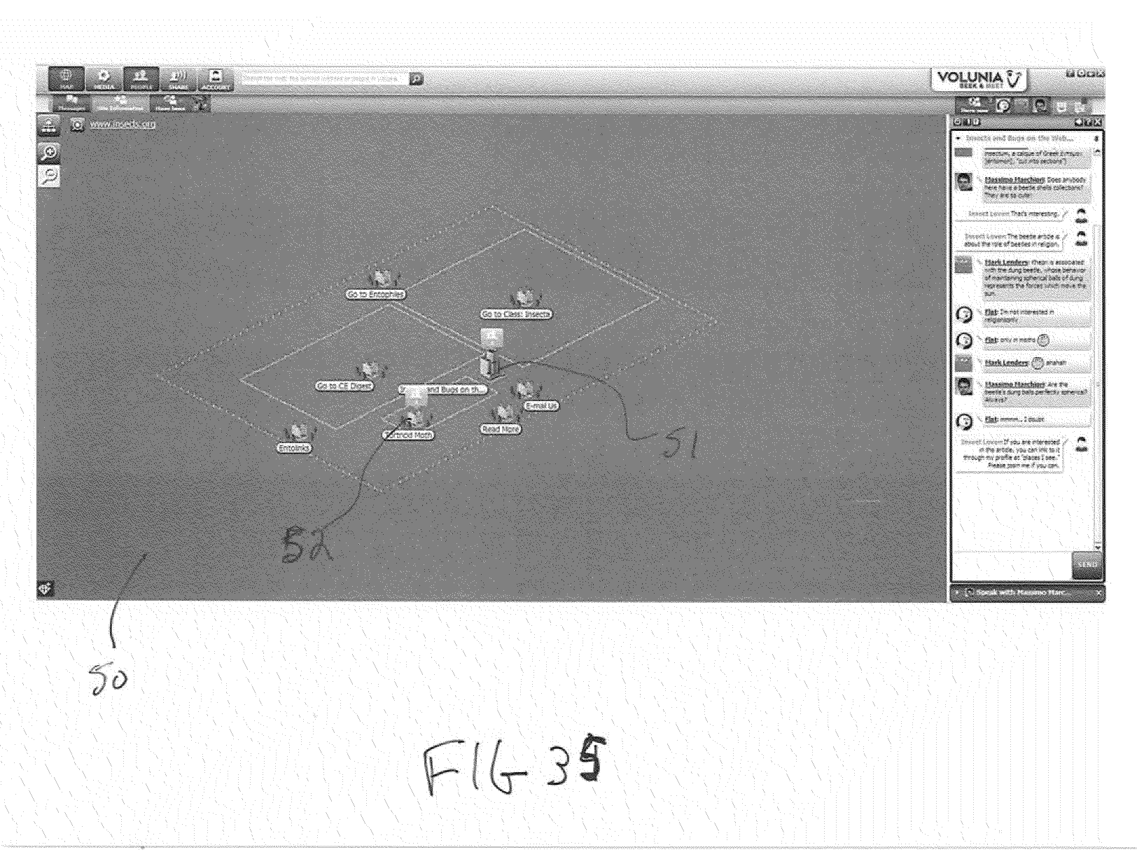

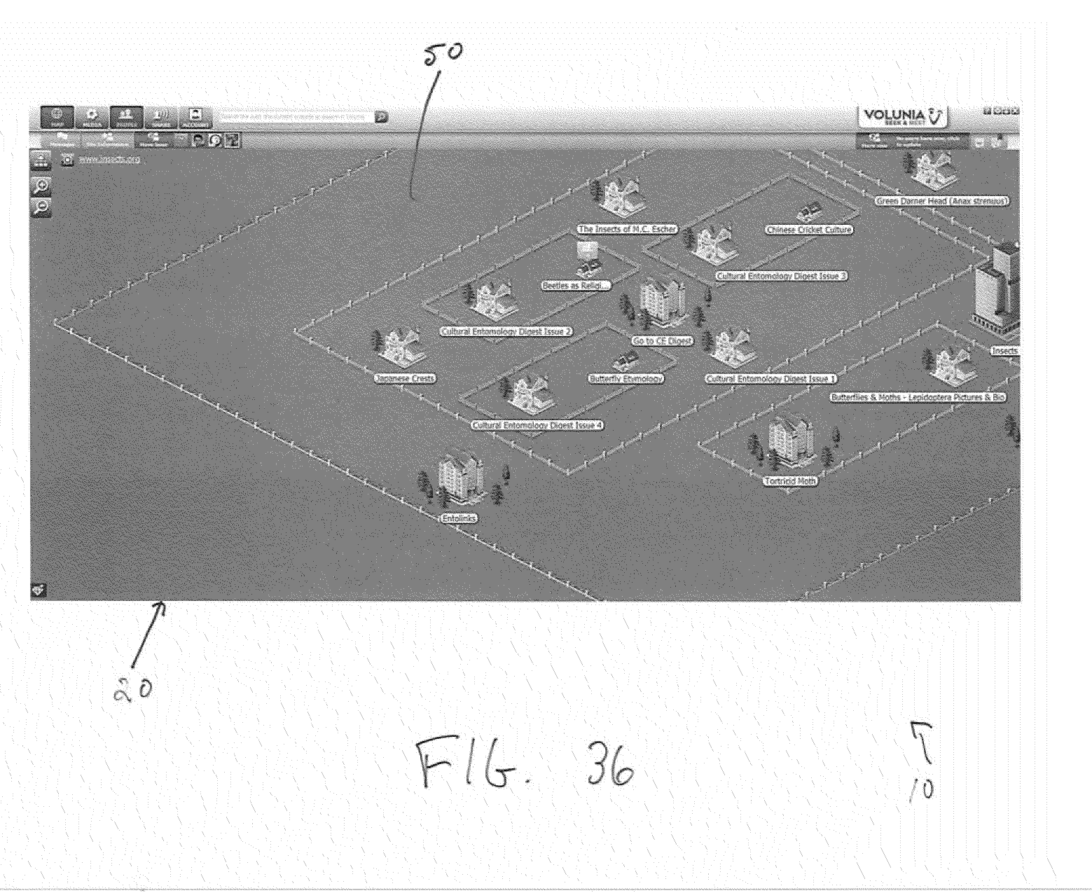

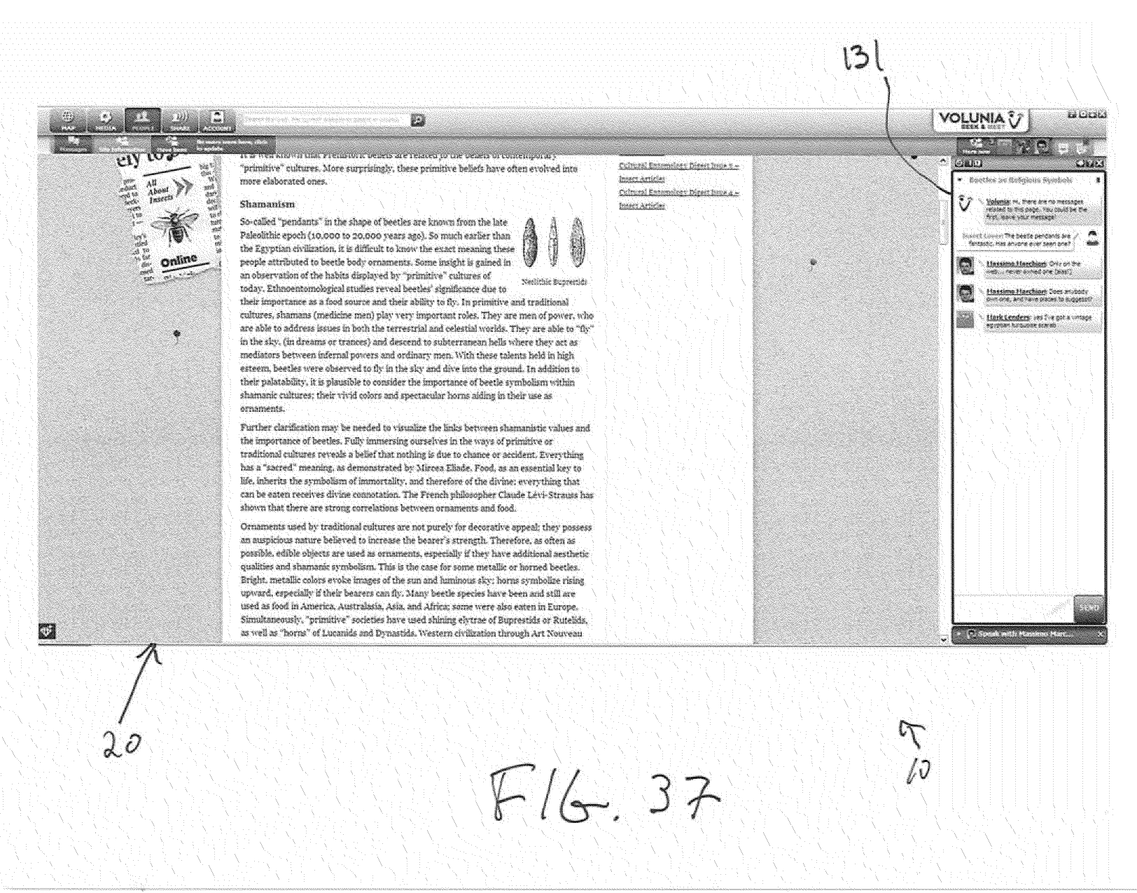

FIGS. 2-3 illustrate a browsing application 10 displaying a home page view. The browsing application 10 may include a browsing area 20 and an application bar 30. The browsing application 10 may be provided as a server-side application, with relatively little or no operative code on the browser-side. Alternatively, the browsing application may also be provided as a direct application and/or as a browser plugin. Such an application and/or plugin may also be able to turn on or off certain functionality described below. For example, a user input (for example, via an icon or keyboard shortcut) may disable or enable the browsing application functionality.

The browsing application 10 may include a combination of applications, for example a combination of one or more client or server applications communicating through a network. The browsing application 10 may be associated with one or more memories that may store data associated with the browsing application 10 discussed herein—for example, user profiles and associated data, browsing history, cached webpages, or the like. For the sake of simplicity, a browsing application 10 may, in certain contexts, be understood to access or include such memories.

The browsing area 20 may include a search form 21. The search form 21 may have an associated search icon to execute web searches. Other interactions may cause web searches to be executed, such as pressing the “enter” key on a keyboard. The search may be directed towards the WWW, within the current website, or towards a database of people or users. These and other types of searches may be selected, for example, through radio buttons as shown in the figures. For example, it may be possible for a user to specifically select and perform image searches, video searches, news searches, or the like. It may also be possible to provide advanced search options to include useful data or metadata associated with particular webpages, images, videos, or the like.

The browsing area 20 may be a dynamic area capable of changing in response to user interactions. As explained in more detail below, the browsing area 20 may include search results (for example, hyperlinks, abstracts, or URLs), map views, container views, social views, webpage views (for example, images generated through hyper-text markup language), media views, or the like. The browsing area 20 may be displayed within a frame or frameset.

The application bar 30 may also include a search form 36 similar to search form 21. The application bar 30 may also include application bar icons such as a map icon 31, a media icon 32, a people icon 33, a share icon 34, an account icon 35, a help icon 37, or an options icon 38. The application bar 30 may also include a minimize/maximize icon 39, which may cause the application bar 30 to be minimized (for example, made thinner with smaller icons as shown in FIG. 3). If the application bar 30 is in a minimized state, the icon 39 may be provided to cause the application bar 30 to be maximized (as shown in FIG. 2). The minimize/maximize icon 39 may change based upon whether the next possible action is to minimize or maximize the application bar 30.

Some of the icons (for example, icons 31-35) may indicate toggle states. According to one technique, an icon is indicated as toggled off with a lighter background color and toggled on with a darker background color. It may be possible to toggle more than one icon to an on state at the same time. Icons may toggle either through a user interaction or automatically.

FIGS. 4-7 illustrate the browsing application 10 displaying search result views 40. Before displaying a search result view 40, search result view data may be generated. Search result view data may be generated by one or more processing units, such as ones on a server or remote computer. The search result view data may be transmitted through a network (for example, the Internet) to one or more processing units for presentation on a display. Such a presentation may result in a search result view 40.

Each search result 41 in the search result view 40 may be displayed in the browsing area 20. The search results 41 may include a title 42, a URL 44, or abstract 43. A number of search results 41 may be displayed in a series of rows. Each search result 41 may correspond to a website, a portion of a website, or a webpage. An interaction with a search result 41 (for example, clicking on the search result title 42) may cause the browsing application 10 to display a corresponding webpage view data (or, for the sake of clarity, “webpage”), such as the one shown in FIG. 8.

For a search result 41, a profile of the corresponding website (or portion thereof) may be generated. The profile may be generated before, during, or after a search is performed. The profile may change according to search terms, user interactions, or other influences. The profile may be static or may change or may be adapted according to factors, such as a user's interest. A user's history may influence the configuration of the profile. For example, the browsing application 10 may be capable of tracking a user's history including queries, page visit history, social messaging content, or the like. Such information may influence the configuration of the profile. As another option, collective information from other users may also influence the profile. Such information may include browsing history on certain webpages or websites, social interaction content at certain webpages or websites, scoring systems or feedback ratings for webpages or websites, or the like.

Such a profile may represent a hierarchical structure of a website (or a portion thereof), including the various levels and links. The profile may also contain estimations of certain aspects of webpages within the website. For example, the profile may contain estimations of each webpage's hierarchical level, degree of importance, degree of interest, degree of significance, etc. (for simplicity, “significance”).

It may be possible for a profile to include or refer to webpages that are outside of the website proper. Such webpages may be referred to as “airport” webpages that may be pages belonging to other websites but are tightly linked to the primary website (or portion thereof). For the purpose of clarity and simplicity, the term “website” as used herein may include such tightly linked webpages that are technically within a distinct website.

The profile may logically group webpages together (for example, by hierarchy, by the pages being at a particular area of a website, or by the pages being closely related). Also, the profile may label a webpage (for example, title the webpage) with text deemed to be reflective of the content of the webpage. The label may or may not be different than the encoded title (for example HTML title) of the webpage. Additionally, the profile may account for the presence of documents, media, media streams, or the like (for simplicity, “documents”) located at or embedded in particular webpages. Such documents may include images, video, audio, text, PDFs, spreadsheets, Microsoft Office® documents, or the like.

Additionally, the results 41 may include a map view icon 45, a container view icon 46, or a social icon 47. All or some of these icons may be displayed next to each search result. Some or all of these icons may be disabled, or indicate that they are disabled (for example, displayed with a dimmer grey color). It may be possible to change the type of icons displayed next to the search results. For example, it may be possible to globally toggle between the container view icon 46 and the map view icon 45 for each search result, as illustrated by FIGS. 4 and 6. Interacting with the map view icon 45, container view icon 46, and social icon 47 may cause the browsing application 10 to display different views. An interaction with the map view icon 45 may cause the browsing application 10 to display a map view. For example, if a pointer hovers over the map view icon 45, a map view 48 may be displayed as a pop-up, as shown in FIG. 5. If the map view icon 45 is clicked, then the browsing area 20 may transition to a display of a map view (such as the map view 40 shown in FIG. 9). An interaction with the container view icon 46 may cause the browsing application 10 to display a container view. For example, if a pointer hovers over the container view icon 26, a container view 49 may be displayed as a pop-up, as shown in FIG. 7. If the container view icon 46 is clicked, then the browsing area 20 may transition to a display of a container view (such as the container view 70 shown in FIG. 14). An interaction with the social icon 47 may cause the browsing application 10 to facilitate social communications with other users and to display social views as will be discussed further on.

In the example shown in FIGS. 4-7, the search phrase “insects” has returned a list of search results 41. The first search result 41 is for a website with a domain name of www.insects.org. The insects.org website will be used as an example or backdrop for various inventive features disclosed herein. The insects.org homepage is shown in FIG. 8.

Map Views

FIGS. 9-13 illustrate the browsing application 10 displaying map views 50 of a website. Before displaying a map view 50, map view data may be generated. Map view data may be generated by one or more processing units, such as ones on a server or remote computer. The map view data may be transmitted through a network (for example, the Internet) to one or more processing units for presentation on a display. Such a presentation may result in a map view 50. For the sake of simplicity, the presentation of a map view 50 can be referred to as a “map.” When the map 50 is displayed in the browsing area 20, the map icon 31 may be toggled to the ON state. By toggling the map icon 31 to the OFF state, the browsing area 20 may be updated to display search results 40 (see, for example, FIG. 4). Toggling may be a result of a user interaction or performed automatically by the browsing application 10 when the map view 50 appears.

The map 50 may also include icons representing and corresponding to respective webpages in the website. There may be various types of such icons, including map view icons 51 and 52. Each of the map view icons 51 and 52 may have a different appearance, such as different sizes, shapes, colors, or the like. The different appearances of the map view icons 51 and 52 may be helpful for indicating that one icon may be more important, at a higher level, of more interest, more significant, etc. (for simplicity, “significance”) than another icon. For example, map view icon 51 is larger than map view icon 52. The larger the icon, the greater its significance may be. The significance of a map view icon may be related to the significance of the corresponding webpage within the website.

The map view icons 51 or 52 may be objects which may be found in certain known maps, such as buildings or geographical features. As shown in FIGS. 9-13, the first map view icon 51 looks like a larger office building while the second map view icon 52 is smaller and looks like a condominium or hotel building. Of course, other schemes or metaphors are possible, such as animals, people, landscape objects, vehicles, or the like. The largest or most prominent icon, such as map view icon 51, may represent the homepage of the website.

The map view icons 51 and 52 may have associated text or labels. For example, map view icon 52 may have associated text 53. When a user interacts with the associated text 53 (for example, hovers over the associated text 53), the associated text 53 may enlarge (see, for example, FIG. 10).

The map may also include perimeter representations (for simplicity, “perimeters”) 54 and 55. The larger perimeter 54 represents the “area” of an entire website. For example, the large perimeter 54 may indicate that all of the icons within the enclosed area defined by the perimeter 54 are part of the website. The interior perimeter 55 within the perimeter 54 represents a logical grouping of webpages within the web site. The perimeters 54, 55 may be depicted, for example, as fences. In addition to their arrangement, the perimeters 54, 55 may be distinguishable by color, size, patterns, or the like.

One or more of the perimeters 54, 55 may contain at least one map view icon that best represents or is the most important of the particular grouping of webpages inside a given perimeter. The map view icon 51 may best represent the website contained in the perimeter 54. For example, the map view icon 51 may represent the home page of the website. Similarly, the map view icon 52 may best represent the grouping of webpages contained within perimeter 55.

The map 50 may also include control icons 60, including a zoom-in icon 62, a zoom-out icon 61, a container view icon 63, a center map icon 65, and a website hyperlink 64. Interacting with the hyperlink 64 may cause browsing application 10 to display the corresponding website, as shown in FIG. 8. The map 50 may also be responsive to other interactions, such as panning (for example, by click-and-drag interactions) or rotating. The map 50 may be 2D, 2.5D, or 3D. The map 50 may also have layers that can be turned on or turned off. Such layers may include different kind of object, such as decorative objects or objects that are not necessarily map icons but represent other augmentations of the map, possibly providing different functionalities when interacted with.

The container view icon 63 may cause the browsing area to replace the map view 50 with a container view (see, for example, FIG. 14). The center map icon 65 may center the map 50 in the browsing area 20. By using the zoom icons 61, 62, the map 50 may be displayed at various zoom levels. Each of the zoom levels may show varying amount of detail. By zooming in, finer detail may be visible. Conversely, by zooming out, finer detail may be hidden. For example, at coarser zoom levels (for example, the top level), some icons or perimeters may not be displayed. As a user zooms in, additional icons or perimeters may be displayed.

Using the insects.org example, FIGS. 9 and 10 show a map 50 of insects.org at the top level. FIG. 11 shows a map 50 of insects.org at a middle level. FIGS. 12 and 13 show a map 50 of insects.org at the lowest level. While FIGS. 9-13 illustrate three levels, the number of levels may vary from website to website or according to other preferences. The map 50 may display different levels at the same time. At the top level, map view icon 51, map view icon 52, and perimeter 55 are visible. As shown in FIG. 10, a user may interact with the map 50, for example, by hovering or clicking on map view icon 52. The map 50 may provide visual feedback (for example, an expand icon “+” or shading within the perimeter 55) so that the user has additional confidence that the intended interaction will be performed.

If a user interacts (for example, clicks on map view icon 52, the expand icon, or the shading within the perimeter), the map 50 may transition to a middle zoom level view, such as that shown in FIG. 11. The map 50 in FIG. 11 shows more detail than those shown in FIGS. 9 and 10. For example, the map 50 in FIG. 11 shows newly-appeared icons for webpages that have been logically grouped within the same perimeter 55 as the webpage represented by map view icon 52. Also, the map 50 in FIG. 11 shows newly-appeared perimeters nested within the perimeter 55. For example, perimeter 57 is shown within perimeter 55 and encompassing webpage icon 56. Like perimeter 55, perimeter 57 may also represent a logical grouping of webpages. The map 50 may transition such that the entire map 50 shows the lower level. Also, the map 50 may transition to display one or more lower levels within perimeter 55 while still displaying higher levels outside of perimeter 55. Such a hybrid map 50 may be generated in response to zoom interactions.

Like map view icons 51 and 52, map view icon 56 also depicts a building. The map view icon 56 building is smaller and looks like a two-story house. Because map view icon 56 is smaller, it may be associated with a webpage having less significance than the webpage associated with map view icon 52 (which, in turn, has less significance than the webpage associated with map view icon 51).

Similar to the interaction described in context of FIG. 10, a user may interact with the map 50 in FIG. 11 to “drill-down” to even deeper zoom levels. By interacting with map view icon 56, the map 50 may transition to a display at the lowest level shown in FIGS. 12 and 13. This zoom level shows an even smaller map view icon 58, which depicts a one-story house. The webpage associated with map view icon 58 may be associated with that of map view icon 56. Also, the webpage associated with map view icon 58 may be less significant than the webpage associated with map view icon 56.

Referring back to FIG. 9, the map 50 displays a top-level visual depiction of the website insects.org. Map view icon 51 is associated with the home page. Map view icon 52 is associated with the “CE Digest,” which is short for Cultural Entomology Digest. A user may know that there are additional webpages logically grouped with that represented by map view icon 52 because there is a perimeter 55 around map view icon 52. If no perimeter is around a particular icon, the associated webpage may be an orphan and not be grouped with other webpages. If a user is interested in exploring the Cultural Entomology Digest, he or she may interact with map view icon 52 and arrive at the map 50 shown in FIG. 11. In this map, icons and perimeters appear within the top-level perimeter for the Cultural Entomology Digest. Additional nested perimeters have appeared within perimeter 55. These nested perimeters include icons corresponding to different issues of the Cultural Entomology Digest. One of these nested perimeters is perimeter 57, which includes map view icon 56 associated with the Cultural Entomology Digest Issue No. 2. If the user desires to find out more about this issue, he or she may interact with map view icon 56 to zoom in to the lowest level shown in FIG. 12. Note that zooming in/out may also be achieved by clicking on the zoom out/in icons 61 or 62, or through other interactions such turning a mouse scroll wheel.

In the map 50 shown in FIG. 12, the user may notice map view icon 58 with the text “Beetles as Religi . . . .” To view more of this associated text, the user may hover over map view icon 58 or associated text and the associated text enlarges as shown in FIG. 13. The user can now see that map view icon 58 is associated with a webpage entitled “Beetles as Religious Symbols.” If the user is interested in this webpage, he or she may interact with map view icon 58 to navigate to the associated webpage shown in FIG. 17. Upon subsequent views of the map 50, map view icon 58 may have a different appearance (for example, a different color) to indicate that the webpage associated with icon 58 has been visited, is in cache memory, or the like.

Container Views

Another way of navigating a website may be through container views. FIGS. 14-16 illustrate the browsing application 10 displaying container views 70 of the insects.org website. Before displaying a container view 70, container view data may be generated. Container view data may be generated by one or more processing units, such as ones on a server or remote computer. The container view data may be transmitted through a network (for example, the Internet) to one or more processing units for presentation on a display. Such a presentation may result in a container view 70. For the sake of simplicity, the presentation of container view data can be referred to as a “container view.” When the container view 70 is displayed in the browsing area 20, the map icon 31 may be toggled to the ON state. By toggling the map icon 31 to the OFF state, the browsing area 20 may be updated to display the search result view 40 (see, for example, FIG. 4). Toggling may be a result of a user interaction or performed automatically by the browsing application 10.

The container view 70 may be similar to views shown in operating systems, such as Windows®. The container views 70 depicted in FIGS. 14-16 may be similar to the “tile” view provided by Windows®. Other views are possible, such as those similar to other Windows® views, including “thumbnails,” “icons,” “list,” “details,” or “explorer.” Like the map view icons 51, 52, 56, and 58, container view icons 72, 73, 78, and 79 may each have an associated webpage. The container view icons may each include descriptive text and/or a hyperlink. As shown in FIGS. 14-16, a hyperlink to the associated webpage and the descriptive text of that webpage may be combined.

The webpages associated with the container view icons may have varying degrees of significance. Like the map view icons, each container view icon may have some indication of the relative significance of the associated webpage. For example, container view icons may have an indicator portion to indicate the relative significance of its associated webpage.

As shown in FIG. 14, container view icon 71 is associated with the home page of the insects.org website and contains a hyperlink thereto. The hyperlink includes descriptive text for the home page. For illustrative purposes, the container view icons may be compared to the map view icons discussed above in conjunction with FIGS. 9-13. Container view icon 71 corresponds to container view icon 51. Container view icon 71 has an indicator portion 72 (a house depiction) that indicates it is associated with the home page of the website. Container view icon 71 also has other indications that it has different significance. For example, it is the first-listed container view icon. Also, it is larger, has a different appearance (appears deeper) and it depicts multiple other folders or documents contained in a larger folder or cabinet file drawer.

As also shown in FIG. 14, container view icon 73 is associated with the Cultural Entomology Digest webpage and contains a hyperlink thereto. The hyperlink may present descriptive text for this page. Still comparing the container and map examples, container view icon 73 corresponds to map view icon 52. Container view con 73 has an indicator portion 74 (shown, for example, as an expand icon “+”) that indicates that it contains additional webpage icons. Container view icon 73 also has other indications that it has different significance. For example, it is the second-listed icon.

If a user interacts with container view icon 73 (for example, clicks on the indicator portion 74), the container view 70 may transition to one such as that shown in FIG. 15. In this container view 70, container view icon 73 is shown as having been expanded. The indicator portion 74 now shows a collapse indicator “-”. If a user interacts with container view icon 73 (for example, clicks on the indicator portion 74), the expanded view may collapse and the container view 70 may transition back to a view such as that shown in FIG. 14.

Looking back at FIG. 15, additional container view icons are shown that correspond to webpages that are logically grouped with the Cultural Entomology Digest webpage. These icons include container view icon 78 which corresponds to the webpage for Cultural Entomology Digest Issue 2. Container view icon 78 also shows an indicator 77 (for example, a checkmark as shown) which indicates that that particular associated webpage has previously been visited. Again comparing the container and map examples, container view icon 78 corresponds to map view icon 56. Container view icon 58 may include an indicator portion that shows an expand indicator.

A user may interact with container view icon 78 (for example, click on the expand indicator) and the container view 70 may transition to one such as that shown in FIG. 16, which shows container view icon 79. Still comparing the container and map examples, container view icon 79 corresponds to map view icon 58. Container view icon 79 may have an indicator portion that looks like a dog-ear or a curled edge of a piece of paper. This may indicate that there are no additional levels below this particular webpage. In this example, container view icon 79 is associated with the “Beetles as Religious Symbols” page and contains a hyperlink thereto. The hyperlink states descriptive text for this page. By clicking on the hyperlink, the browsing area 20 may transition to display the associated “Beetles as Religious Symbols” webpage as shown in FIG. 17.

In addition to container view icons that are associated with webpages, other container view icons may be associated with particular documents (for example, images, video, PDF files, and the like). While the container view icons are shown using the folder/file metaphor, other hierarchical metaphors may also be possible. It may be possible to scroll (vertically or horizontally) or page or otherwise navigate through the container view 70 if all of the container icons cannot fit on one screen page. It may also be possible to dynamically change the appearance of the container view icons (for example, allow the user to make the icons larger or smaller).

While the illustrated examples of container views 70 show different pages at the same hierarchical level, it may be possible to show container views 70 with pages at different levels. Such views may be similar to a Windows® “explorer” display.

Media Views

FIGS. 19-20 illustrate browsing application 10 displaying media views 80. Before displaying a media view 80, media view data may be generated. Media view data may be generated by one or more processing units, such as ones on a server or remote computer. The media view data may be transmitted through a network (for example, the Internet) to one or more processing units for presentation on a display. Such a presentation may result in a media view 80. For the sake of simplicity, the presentation of media view data can be referred to as a media view. When the media view 80 is displayed in the browsing area 20, the media icon 32 may be toggled to the ON state. By toggling the media icon 32 to the OFF state, the browsing area 20 may be updated to display the webpage (see, for example, FIG. 17). Toggling may be a result of a user interaction or performed automatically by the browsing application 10.

Turning for a moment to FIG. 18, the browsing application 10 is shown as displaying the insects.org homepage and a media menu 81. The media menu 81 includes an images icon 82, an audio icon 83, a video icon 84, a documents icon 85, and an “other” or miscellaneous icon 86. As discussed, “documents” may refer to documents, media, media streams, or the like located at or embedded in particular webpages. A document may include one or more images, video, audio, text, PDFs, spreadsheets, Microsoft Office® documents, or the like. The miscellaneous icon 86 may correspond to documents or file types not represented by the other media menu icons.

The media menu 81 may appear by toggling the media icon 32 to the ON state. The media menu 81 may disappear by toggling the media icon 32 to the OFF state or by interacting with the “X” icon in the media menu 81. The media menu icons 82-86 may change appearance based on whether a particular type of document is available at a given website. For example, a media menu icon may change color to indicate the presence of a particular type of document. As shown in FIG. 18, the images icon 82 is darker than the other media menu icons 83-86. In this particular example, this indicates that there are image documents available at insects.org, but the other types of documents (audio, video, etc.) are not present within the website. If other document types were available, it may be possible to interact with a different one of the media icons 83-86. As a result, the media view 80 may transition to display a different category of documents. For example, if audio documents were available, a user may click on the audio icon 83 and the media view 80 may transition to display the audio documents available at insects.org.

By interacting with the images icon 82, the browsing area 20 of the browsing application 10 may transition to a display such as that shown in FIG. 19 showing a media view 80. The media view 80 may include one or more document previews 90 associated with corresponding documents. Each document preview 90 may include a thumbnail image 91, a document name 92, a URL 94 specifying the location of the associated document, or a social interaction icon 93 (which may be similar to other social interaction icons discussed herein). In the case of image documents, the thumbnail image 91 may be a scaled down version of the image. For other document types, other types of appropriate thumbnail images may be used. For example, for a PDF document, a PDF icon may be used. As another example, for a video document, a thumbnail of a single frame of the video may be used.

As shown in FIG. 19, the media menu 81 is still visible, but now a search form 87 and a “see all” icon 88 have appeared. The search form 87 may allow a search within the images available at insects.org. After performing a search through the search form 87, the media view 80 may transition to display only a subset of document representations 90 that include the search term. The see all icon 88 may then be used to transition back to the full set of document representations 90 for the particular type of document. It may also be possible to see different document types listed or displayed together.

FIG. 19 shows a plurality of document representations 90 for image documents. As shown in the media menu 81, the images icon 82 is highlighted. It may be possible to scroll (vertically or horizontally) or page or otherwise navigate through the media view 80 if all of the document representations 90 icons cannot fit on one screen page. It may be possible to change the display of document representations 90 to those that can be found across the website or to those that can be found at a particular webpage. It may be possible to change the size or other appearance aspects of the document representations 90. For example, it may be possible to reduce or enlarge the size of the document representations 90 including the thumbnail images 91 to adjust the number of representations 90 that will be displayed on one media view display page.

If a user interacts with the document representation 90 (for example, clicks on the thumbnail image 91), the media view 80 may transition to one such as that shown in FIG. 20. In this example, a user has clicked on the img-1.jpg (moth) thumbnail and the full-sized image document representation 95 has been displayed. The remainder of the browsing area 20 display has been “grayed” so that attention may be more clearly focused on the full-sized image document representation 95. The representation 95 may include a full-sized or larger-sized document and a portion to close the display of the representation 95 and revert back to the media view 80 including the document representation 90. The representation 95 may facilitate downloading the document, for example, through a “download” link. The representation 95 may also facilitate quick navigation to the webpage containing the document, for example, through a “go to page” link.

A document may open as an object within the browsing application 10 or may open in an associated application. For example, a PDF document may open in Adobe Acrobat®. A document may also open in an application plug-in associated with the browsing application 10. A document may open through navigation to another webpage. For example, a video document may open in a video sharing website such as YouTube®. A document (for example, a text document, PDF, or a sound file) may open in preview or view/listen mode through browser plugins or through applications served by a given web service (for example, web-based office applications, an online newspaper, or an online streaming music service).

Sharing

FIGS. 23A and 23B illustrate the browsing application 10 displaying sharing features. By toggling the share icon 34 to the ON state, a sharing menu may appear. The sharing menu may provide options to share a particular webpage, for example, through the WWW, Facebook, Twitter, or e-mail. An icon may be provided to enable each of these actions. Of course, other sharing modes are also possible, for example, through other communications or networking portals. In addition to sharing the webpage, the sharing tools may also enable sharing of a map view or container view of a website. It may also be possible to share map views or container views that are not top-level views. For example, if a user has drilled down in a map view to a lower layer, it may be possible to share that particular view. With regard to the WWW sharing technique, markup language code (for example HTML code) or a hyperlink may be provided to embed the map view or container view in a webpage.

Customization

It may be possible to select different appearances for map view, container view, or media view. For example, different “skins” or other techniques may be used to change overall visualization schemes. The locations, sizes, colors, types, etc. of the various objects in a map view, container view, or media view may be adjusted or dynamically selected according to preference. It may be possible for the user of the browsing application 10 to perform such adjustments or changes. It may also be possible for a website owner to provide information to specify the appearance of a map. For example, a website owner could provide a profile of the website or information that may be used as part of a profile for the website. This information could include the arrangement of the webpages, the name of the webpages, the importance of the webpages, a map shape, a theme, or other sort of arrangement.

For example, a website owner or manager may prefer to control the appearance of a map view for the website. For example, the manager of a zoo website may be able to provide map information so that the map view for the zoo website looks like a map of the zoo. Such a map may include webpage icons that look like animals and perimeters that group the animals appropriately. The layout of such a map may also be specified, for example, to match the layout of the zoo itself.

Furthermore, as discussed above, it may be possible to embed a map view or a container view into a website. Therefore, the zoo website may embed its customized zoo map into a page in its website. Thus the zoo website manager may leverage the map functionality available through the browsing application 10 to provide an embedded, customized, and interactive map of the zoo website.

Embedding of functions may include some or all of the aspects of the browsing application 10 discussed herein. For example, embedded functionalities may allow interactions with an embedded map by zooming in/out, panning, rotating, or the like. An embedded map may include social indicators and other icons associated with a map view. It may be possible to switch from a map view to other views such as a container view or a media view. It may be possible to provide icons that may spawn a search of content (for example, media content) within a webpage or website. It may be possible to provide icons that indicate social functionalities, such as the number of visitors at a webpage or website, current visitors, recent visitors, or the like. These are but a few examples and, as mentioned, some or all of the functionality of the browsing application 10 may be embedded as an object within another webpage.

User Profiles and Social Interactions

In addition to presenting websites through map views or container views, the browsing application 10 may facilitate users to socially interact with one another. For example, it may be possible for the browsing application 10 to facilitate social interactions with users who are using similar or compatible browsing applications.

The browsing application 10 may maintain account information for one or more users, for example, in one or more associated memories. For example, different users may be able to log in and log out to assume his or her particular user profile. As shown in FIG. 24, when the account icon 35 is toggled to the ON state, an account menu is displayed including a profile icon and a login/logout icon. Interacting with the profile icon may cause the browsing area 20 to transition to that of FIG. 25, in which a profile display 100 is presented. A user may be able to update or edit his or her account information through interacting with the profile display 100. The profile display 100 may have a variety of information associated with a user including biographical information, avatar information, privacy information, stored documents, friends list, managed websites, browsing history, or the like. The profile display 100 may include other editable aspects about a user, such as favorite websites, favorite webpages, favorite maps, favorite map icons, interests, hobbies, relationship status, religious orientation, place of residence, gender, age, country of citizenship, place of origin, schools attended, birthday, occupation, or the like.

In the particular profile display 100 shown in FIG. 25, various tabs organize a user's profile information. Of course, the particular tabs described herein are but one way of displaying or allowing a user to edit account information. In this example, the user information tab provides access to editing or viewing a user's biographical information. The avatar tab provides access to viewing or editing (for example, uploading or choosing from a predetermined selection) a user's avatar.

As shown in FIG. 26, the settings tab provides access to various security and privacy settings. For example, this tab may provide a location to change passwords, set the user's preferred language, or to opt in/out of email notifications. The settings tab also discloses privacy information (called “Profile Information”) which may allow a user to change his or her privacy settings. These privacy settings may be displayed in a table with rows of radio buttons. On the left column, a variety of types of personal information may be listed—for example, birthdate, country, state/province, zip code/cap, city, about me, chat to me, reach me, places I've seen, visibility of my friends, name/surname, or visibility of my documents (for example, image documents). For each type of personal information, four different privacy settings may be offered. The selected privacy setting may determine who can or cannot see a particular type of personal information. The first setting may allow user information to be accessed by all other users, including anonymous users. The second setting may allow access to only registered users (for example, users who have accounts compatible with the browsing application 10). The third setting may allow access to only friends. The fourth setting may keep information private from any other user. If certain privacy settings are not available or possible, it may not be possible to make those selections (for example, disabled radio buttons).

The “my images” tab may be used to view, add, remove, or edit images which may be stored along with a user's account information. More generally, it may be possible to provide storage or access to various other types of documents, including the types of documents discussed herein.

As shown in FIG. 27, the “places I see” tab may be used to view the user's browsing history. The browsing history may include a list of webpages each of which may include a URL, a page title or other descriptive text, a map view or a portion thereof, a container view or a portion thereof, or other useful identifying information. It may be possible to delete some or all of the links in the browsing history. It may be possible to organize the webpages in folders or other ways, such as expanding or collapsing sets or subsets of webpages. It may be possible to annotate or retitle the webpage links. It may be possible to change the image view to display a portion of a map view, a thumbnail of the webpage, an icon representative of the webpage, or the like.

As shown in FIG. 28, the “my friends” tab may display a list of a user's friends. The list may include names, handles, avatars, or other useful identifying information. In the particular example shown, this list of friends includes the friends' names and avatars. It may be possible to interact with a friend's name or avatar to view additional information about that friend (see FIG. 30).

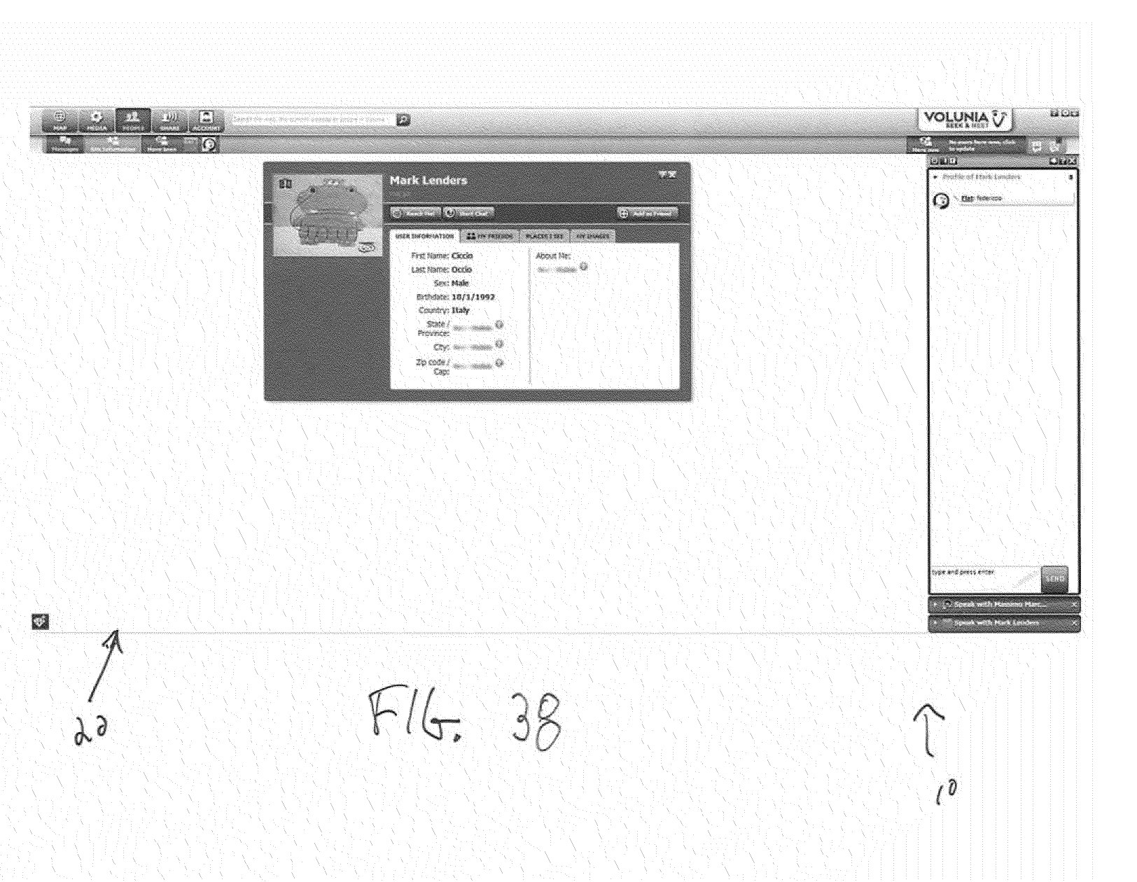

Also, a link is provided to “show details about all friends.” This link may cause the browsing area 20 to transition to that shown in FIG. 29, which shows a set 110 of icons and information associated with each friend. Each set 110 may include a name 111, an avatar 115, a social interaction icon 112, a “reach me” icon 113, or a URL 114. The social interaction icon 112 may initiate a dialogue (for example, chat) or other interaction with the friend (see FIG. 38). The URL 114 may identify the “location” on the Internet where the friend is currently or was most recently visiting. If a user has more restrictive privacy settings, certain items in the set 110 may be unavailable or shown as disabled. For example, the friend Niki Rocco's set 110 does not provide his most recent browsing location or the ability to “reach” him through the “reach me” icon 113.

An interaction with the “reach me” icon 113 may cause the browsing application 10 to display the webpage located at the URL 114 in the browsing area 20. For example, the friend Massimo Marchiori was most recently visiting the “Beetles as Religious Symbols” webpage. By clicking on the “reach me” icon, the browsing application 10 may transition to a display of that page, for example, as shown in FIG. 16.

By interacting with the set 110 (for example, clicking on the friend's name), the browsing area 20 may transition to a display such as that shown in FIG. 30. This type of display may also appear in the browsing area 20 in response to other interactions, such as an interaction with a user's name or avatar listed in the people bar 90 or appearing in a social interaction dialogue. In the display depicted in FIG. 30, a more complete set or unabbreviated set 120 of a user's viewable information may be presented. As another option, unabbreviated sets 120 of information may be included in the friend list, rather than on a separate page view.

The unabbreviated set 120 may include the user's name, avatar, or status (online, offline, unknown, etc.). The set may also include additional information, such as biographical information, friend information (for example, a list of the user's friends), browsing history, or stored documents (for example, images). As shown in FIG. 30, certain biographical information may or may not be provided according to the user's privacy settings. In this case, Massimo has prohibited anyone from seeing his state/province, city, or zip code/cap. However, since the viewing user is Massimo's friend, he or she is able to see his birthday and country as well as his “about me” information.

As shown in FIG. 31, a user's browsing history may be viewed. The browsing history may include a list of webpages, each including a URL, a page title or other descriptive text, a map view or a portion thereof, a container view or a portion thereof, or other useful identifying information.

The unabbreviated set 120 may include a “reach me” icon 121, a social icon 122, or an add/remove friend icon 123. The behavior of the “reach me” icon 121 may be similar to that of the “reach me” icon 113. For example, interacting with the “reach me” icon 121 may cause the browsing area 20 to transition to a display of the webpage most recently visited by the user. The social icon 122 may initiate a dialogue with the user.

If the user is not a friend, the icon 123 may appear as an add friend icon. The add friend icon 123 may be used to send a friend request to the user. The friend request may specify a potentially common interest. For example, if both the friend requestor and the user are or have recently been visiting a webpage or website, the webpage or website may be a potentially common interest. Such a potentially common interest may be automatically populated in the friend request.

FIGS. 21-22 illustrate the browsing application 10 displaying a people toolbar 90. By interacting with the people icon 33, a people toolbar 90 may appear (as shown in FIG. 21A). The people toolbar 90 may automatically appear in response to user interactions with the various social interaction icons disclosed herein. By enabling the people toolbar 90 it may be possible for a user to socially interact with other users. The people toolbar 90 is shown in two pieces and in greater detail in FIGS. 21B and 21C. The people toolbar 90 includes a messages icon 91, a site information icon 92, a “have been” icon 93 and associated user avatars 94, a “here now” icon 95 and any associated user avatars, a friendship requests icon 96 and a friends online icon 97.

As shown in FIG. 22, an interaction with the messages icon 91 may cause a messages menu to appear. The messages menu may show indicators of available (for example, active) dialogues. In this example, there are four available dialogues—one public dialogue at the Volunia EN page, and three private dialogues with different users. By interacting with one of the dialogue indicators, the browsing area 20 may transition to display the particular dialogue. The site information icon 92 (as shown in FIG. 21B) may provide additional information regarding the current website such as the name/address of the website, name/address of the currently visited webpage, social statistics of the webpage/website (for example, the number of visits, trends, or the like), WHOIS information for the website, or a contact person for the website.

The “have been” icon 93 includes an area that contains the avatars of users who have been at the webpage or website. By interacting with one of the avatars, the browsing area 20 may transition to display the user's information, such as the unabbreviated set 120 of the user's information. The appearance of an avatar may indicate other aspects of a particular user. Such aspects may include online status or privacy status. For example, the avatar may have a different border depending on whether the user is online or offline. Additionally, interacting with the avatar may provide information about the user, such as the user's name or online status. Avatars appearing in other places of this application (for example, in dialogues) may have similar appearances or behaviors.

The “here now” icon 95 and any associated user avatars may be similar to the “have been” icon 93 and associated user avatars. The avatars appearing next to the “here now” icon 95 may represent users who are currently online and visiting the particular webpage. An interaction with the friendship requests icon 96 may allow a user to see his or her pending friendship requests—either outgoing or incoming. For the incoming friendship requests, the user may be able to decide whether he or she wants to be friends with another requesting user. By interacting with the friends online icon 97, a user may be able to view his or her friends who are online, for example, as a list of avatars and user names.

Turning now to FIG. 32, the browsing application 10 is shown as displaying a search result view 40 in response to a search for the term “insects.” In many respects, FIG. 32 is similar to FIG. 4. For example, there are a plurality of search results 41 listed in a series of rows. Each search result may include a title 42, a URL 44, an abstract 43, a map view icon 46, a container view icon 46, or a social icon 47.

In FIG. 32, however, the social icon 47 in the first-listed search result 41 has a different appearance than other social icons. The changed appearance may indicate that there is social activity recently or currently taking place at that website or webpage. Such a change in appearance of the social icon 47 may include a change in size, color, arrangement, depiction, or the like. In this particular example, the social icons 47 for the second and subsequent search results 41 are darker in color and show empty text bubbles. The social icon 47 in the first search result 41 has a lighter color and shows silhouettes that indicate the presence of users.

Also, the social icon 47 now shows two numbers, although there could be more or less numbers depending on preferences. Furthermore, instead of numbers, other quantity-type indicators may be used (for example, bars, colors, or the like). As shown, the first number indicates the number of online users who have recently or are currently visiting the homepage at the website insects.org. The second number (in parentheses) indicates the number of online users who have recently or are currently visiting any webpages within the insects.org website. As may be apparent, the browsing application 10 may be able to track the status and locations of other users. For example, the browsing application 10 may be able to track the status and locations of users who are logged in to the browsing application 10 or a similar browsing application. The browsing application 10 may or may not track anonymous users. The browsing application 10 may or may not track registered users who opt not to have their locations known to any other users.

The presence of social activity at a particular webpage or website may impact how the search results 41 are displayed in the search result view 40. For example, the number of visitors may increase the ranking of a particular search result 41, thereby propelling the search result 41 towards or up to the first-listed result. Other factors may effect a ranking of a webpage or website, including visitor demographics, search trends, language of the webpage or website, or the type of interactions performed at the webpage or website (for example, writing comments, page views per user, time on webpage or website, or the like). Rankings may be affected based on the identity of visitors, such as degrees of separation or friendship between visitors and the user. For example, rankings may be increased if visitors to a website tend to be friends or friends of friends. Such factors may be adjusted according to a user's preference or the user's profile. For example, rankings may be effected by whether profiles (or aspects thereof) or navigation patterns of other visitors are similar to those of the user.

It may be possible for users to provide feedback through a scoring or rating system. For example, the browsing application 10 may provide facilities which allow users to subjectively evaluate a webpage through techniques such as “like”/“dislike,” numerical rating (for example, a number of “stars”), numerical ranking of certain aspects of a webpage/website, or the like. Such feedback may influence a ranking of a particular webpage or website.

An interaction with the social icon 47 may cause the browsing application 10 to transition to a display such as FIG. 33 or FIG. 34. In FIG. 33, the browsing area 20 shows the insects.org homepage and the people bar 90 shows that there are five new messages (on the messages icon 91) and two users currently visiting this webpage. By interacting with the messages icon 91, the browsing area 20 may transition to that shown in FIG. 34. This display may also directly result from an interaction with the social icon 47 shown in FIG. 32.

FIG. 34 illustrates the browsing application 10 presenting the insects.org webpage and social view data. Social view data may be generated by one or more processing units, such as ones on a server or remote computer. The social view data may be transmitted through a network (for example, the Internet) to one or more processing units for presentation on a display. Such a presentation may result in a social view 130. For the sake of simplicity, the presentation of social view data can be referred to as a “social view.” The social view 130 is indicated as a sidebar, but other arrangements are possible. The social view 130 may include one or more dialogues 131. Each dialogue 131 may be expanded or collapsed. If one dialogue 131 is expanded, then the other dialogues 131 may be collapsed. A dialogue 131 may be a portal for interacting with one or more users. One such way to interact may be to “chat.” A dialogue 131 may facilitate or include text chat, video chat, audio chat, a combination thereof, or the like. In the present example, the dialogue 131 shows a text chat between several users. User comments may be listed in conjunction with an identifier (for example, avatar, user name, or the like).

Each dialogue 131 may have a title, such as the name of a website, webpage, or user. In this example, the first dialogue 131 is titled according to the title of the displayed webpage, and the second dialogue 131 is titled according to a user and it also shows the user's avatar. The second dialogue 131 may be a private chat, for example, with another user or friend. A dialogue 131 may include a show/hide timestamp icon 132 (which may show/hide timestamps for each message in the dialogue 131), an enable/disable automatic scrolling icon 133, a flag inappropriate messages icon 134, a maximize/minimize icon 135 (for maximizing or minimizing the size of the dialogue window), a help icon 136, and a close social view icon 137. The social view 130 may be closed by either interacting with the close social view icon 137 or toggling the messages icon 91 to the OFF state. The dialogue 131 may also include a form 139 or some other way for adding content to the dialogue 131. For example, a text form may be used for text chat. Additional devices such as microphones or cameras may be used, for example, to facilitate audio or video communications.

A dialogue 131 may also have a persistence icon 138, which may facilitate making the dialogue 131 persistent across other views in the browsing area 20 of the browsing application 10. For example, the dialogue 131 in FIG. 34 (entitled “Insects and Bugs on the Web . . . ”) is associated with the homepage of insects.org (which is shown in FIG. 34). If this dialogue 131 is made persistent, then it still may appear even after the browsing area 20 transitions to display other views (for example, map views, container views, search result views, views of other websites, views of other webpages whether or not within the same website, or the like). Therefore, it may be possible to have an active dialogue 131 associated with a first webpage. It may then be possible to navigate to a second webpage (whether or not in the same website of the first webpage) while still viewing or participating in the active dialogue 131 associated with the first webpage. The same principles may apply to public or private dialogues 131. By disabling persistence through interacting with the persistence icon 138, the dialogue 131 may disappear when the browsing area 20 transitions to other views. The dialogue 131 may then reappear when the browsing area 20 returns to the original view. When a dialogue 131 reappears, it may be empty or it may contain prior social interactions. For example, a dialogue 131 may disappear for a period of time and when it reappears, it may contain social interactions that occurred while the dialogue 131 was not visible. The persistence of the dialogue 131 may be enabled, disabled, or facilitated by the persistence icon 138 or through other ways (for example, software default settings, user preference, or the like).

The browsing application 10 may facilitate a user to socially communicate with different groups of other users. For example, at a first webpage or website, the user may be able to interact through a dialogue with other visitors at the first webpage or website. The user may then be able to employ the browsing application 10 to navigate to a second webpage or website, at which the user may be able to interact through a different dialogue with other visitors at the second webpage or website. The identities of the visitors at the first webpage or website may be different from the identities of the visitors at the second webpage or website. As another option, through the use of persistence, it may be possible for a user to view the different dialogues simultaneously while viewing the first or second webpage/website or while the browsing area 20 has transitioned to any of the other various views discussed herein.

The browsing application 10 may present social views 130 along with any of the various views disclosed herein, including webpages. For example, one or more social views may be associated and presented along with one or more webpages. Thus, the browsing application 10 may provide users with the ability to interact at virtually any webpage on the WWW, irrespective of whether such a webpage provides native social interaction features, such as chat or comment posting.

A dialogue 131 may also be quasi-persistent. For example, a dialogue 131 may be persistent across a webpage view, a map view of the webpage, or a container view of the webpage. The dialogue 131, however, may disappear if the browsing application 10 is directed to a different webpage. If the persistence icon 138 indicates that the dialogue 131 is not persistent, then the dialogue 131 may still be quasi-persistent. A dialogue 131 may also always be persistent. For example, in certain examples shown, private chat dialogues may be always persistent until they are closed.

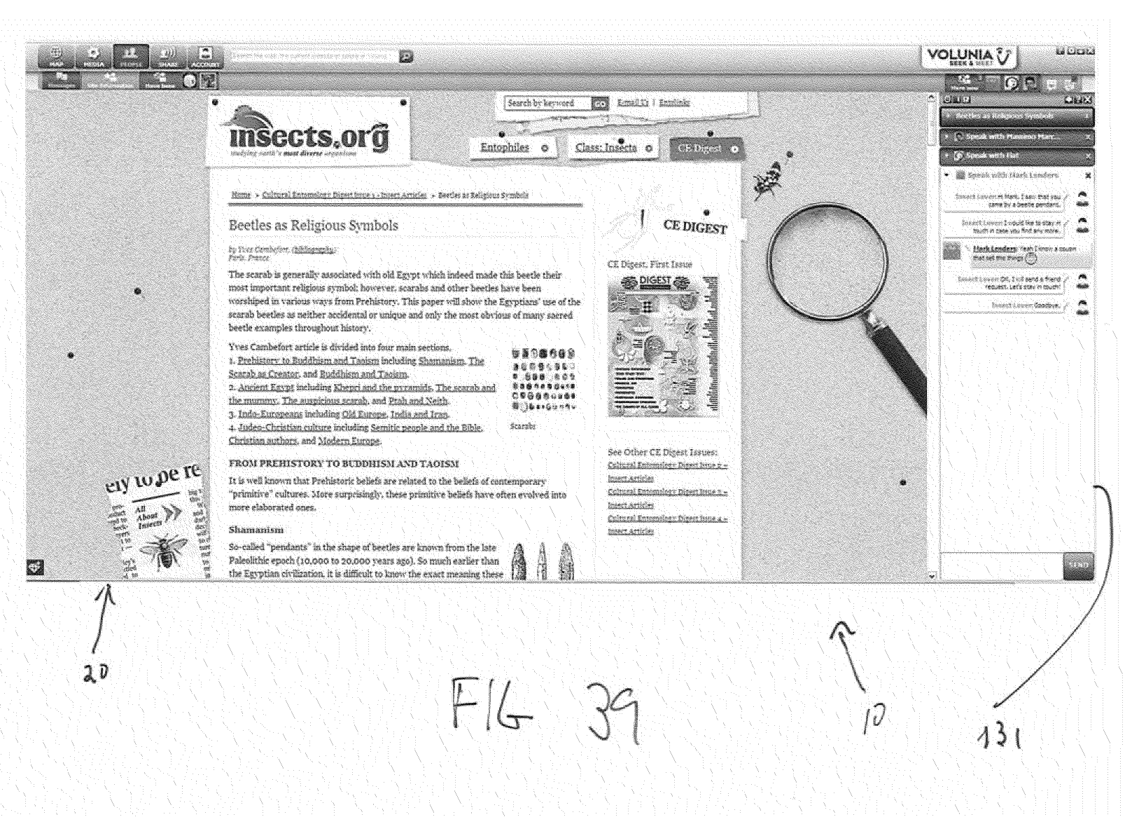

In the example of FIG. 34, several interested or curious users are chatting in the dialogue 131 corresponding to the insects.org homepage. The user (Insect Lover) of the displayed browsing application 10 notes that there is an article about the role of beetles in religion and invites others to find the article by viewing “places I see” in his profile, which is shown in FIG. 27. At the profile, other users may interact with the second link which may facilitate the browsing area 20 to transition to a view of the “Beetles as Religious Symbols” webpage (for example, as shown in FIG. 37 or 39).

Looking back at FIG. 34, a user may interact with the map icon 91 to cause the browsing area 20 to display a map view of the insects.org website as shown in FIG. 35. The browsing area 20 of the browsing application 10 in FIG. 35 may be similar to that shown in FIG. 9. In both cases, the map view 50 is shown. However, in FIG. 35 there are additional social icons associated with webpage icons 51 and 52. These social icons may indicate the number of users presently visiting or interacting at the associated webpages (or group of webpages) of the website. Also, FIG. 35 shows the dialogues 131 that were also shown in FIG. 34. Thus, these dialogues 131 are either persistent or quasi-persistent. Although not depicted, similar social icons and persistent or quasi-persistent dialogues may appear when viewing a container view of the website.

After a time, the user of browsing application 10 interacts with the application to drill down and view the “Beetles as Religious Symbols” webpage in the map view, as shown in FIG. 36. This map view 50 may be similar to that shown in FIG. 13, but now there is a social icon displayed by webpage icon 58 that indicates there are four users who were recently or are currently visiting or socially communicating at this webpage. The user may then navigate, for example by interacting with webpage icon 58, to the “Beetles as Religious Symbols” webpage as shown in FIG. 37. A dialogue 131 is now available to interact with other users regarding the “Beetles as Religious Symbols” webpage. The user Insect Lover reads that user Mark Lenders has a vintage scarab. Insect Lover may wish to communicate privately with Mark Lenders. To initiate such a dialogue, the user Insect Lover may interact with the name or avatar for Mark Lenders and the browsing area 20 may transition to a display such as that shown in FIG. 38, which shows the unabbreviated set 120 of user information for Mark Lenders. The user Insect Lover may interact with the “start chat” icon to initiate a private dialogue 131 with Mark Lenders.”

As shown in FIG. 39 Insect Lover may then return to the “Beetles as Religious Symbols” webpage and continue or participate in a private dialogue 131 with Mark Lenders. Insect Lover is interested in staying in touch with Mark Lenders and states that he will send a friend request.

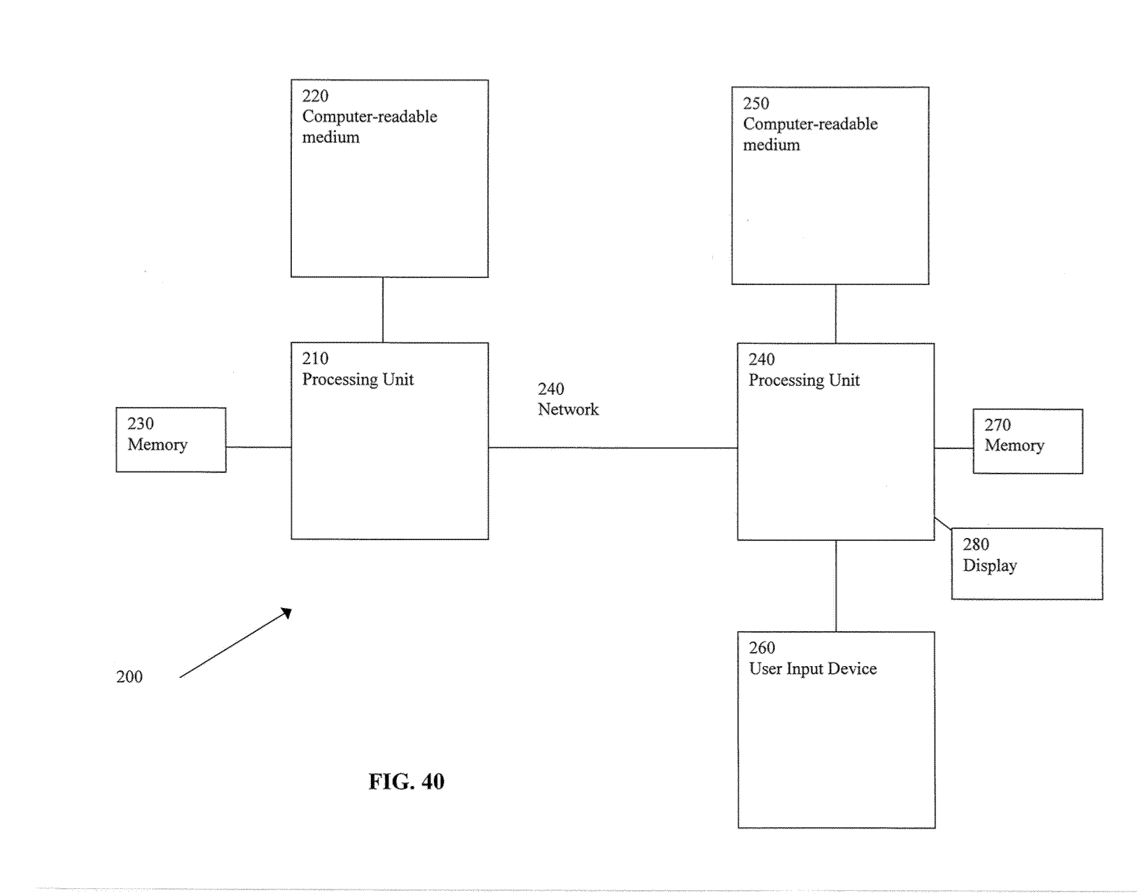

FIG. 40 illustrates a system 200 for implementing a browsing application. The system may include processing units 210 or 240 which may communicate with each other through a network 240. Each of the processing units 210 or 240 may include multiple processing units. The processing units 210 or 240 may be in communication with one or more computer-readable mediums 220 or 250. The processing units 210 or 240, either individually or in combination, may execute software instructions stored on one or more of the computer-readable mediums 220 or 250. The processing units 210 or 240 may be in communication with one or more memories 230 or 270. Each memory 230 or 270 may include multiple memories. These memories may be used for storage and retrieval of information and data associated with the browsing application (for example, user information or browsing history).

The processing unit 240 may be in communication with one or more user input devices 260 (for example, a keyboard, mousing device, touch screen, voice control device, camera, or the like). A user may be able to interact with the browsing application through one or more user input devices 260 to perform operations described herein. An interaction may include a mouse movement, mouse click, mouse hover, keyboard input, touch interaction (for example, pinching or touching to zoom in or out), eye movements, body movements, mouse gestures, touch gestures, or the like. In response to a user interaction, at least one of the processing units 210 or 240 may receive an interaction signal. For example, if a user clicks on or hovers over an icon with a mouse, this may cause the processing unit 240 to receive an icon interaction signal. As another example, if a user clicks on a hyperlink or a shortcut, this may cause the processing unit 240 to receive a navigation signal. These are just a few examples. Any type of interaction with the browsing application 10 may result in a corresponding signal that is received by the processing unit 240.

The processing units 210 or 240 may generate data, such as data representative of a website, map view data, container view data, social view data, search result view data, or the like. The processing units 210 or 240 may transmit such data to the display 280 to present website views, map views, container views, search result views, social views or the like.

Aspects of the techniques described herein may be implemented in digital electronic circuitry, computer software, firmware, or hardware, including the structures disclosed herein and their structural equivalents, or in various combinations. Aspects of the techniques described herein may be implemented as one or more computer programs, for example, one or more sets of program instructions residing on or encoded in a computer-readable storage medium for execution by, or to control the operation of, one or more processing units. Alternatively or in addition, the instructions may be encoded on an artificially-generated propagated signal, for example, a machine-generated electrical, optical, or electromagnetic signal that may be generated to encode information for transmission to a suitable receiver apparatus for execution by one or more processing units. A computer-readable medium may be, or be included in, a computer-readable storage device, a computer-readable storage substrate, a random or serial access memory array or device, various combinations thereof. Moreover, while a computer-readable medium may or may not be a propagated signal, a computer-readable medium may be a source or destination of program instructions encoded in an artificially-generated propagated signal. The computer-readable medium may also be, or be included in, one or more separate physical components or media (for example, CDs, disks, or other storage devices).

Certain techniques described in this specification may be implemented as operations performed by one or more processing units on data stored on one or more computer-readable mediums or received from other sources. The term “processing unit” may encompass various kinds of apparatuses, devices, or machines for processing data, including by way of example a central processing unit, a microprocessor, a microcontroller, a digital-signal processor, programmable processor, a computer, a system on a chip, or various combinations thereof. The processing unit may include special purpose logic circuitry, for example, a field programmable gate array or an application-specific integrated circuit.

Program instructions (for example, a program, software, software application, script, or code) may be written in various programming languages, including compiled or interpreted languages, declarative or procedural languages, and may be deployed in various forms, for example as a stand-alone program or as a module, component, subroutine, object, or other unit suitable for use in a computing environment. Program instructions may correspond to a file in a file system. Program instructions may be stored in a portion of a file that holds other programs or data (for example, one or more scripts stored in a markup language document), in a dedicated file or in multiple coordinated files (for example, files that store one or more modules, sub-programs, or portions of code). Program instructions may be deployed to be executed on one or more processing units located at one site or distributed across multiple sites connected by a network.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for generating map view data representative of at least a portion of a website, the method comprising:
associating a first webpage icon with a first webpage of the website, wherein the first webpage icon corresponds to a degree of significance of the first webpage;
associating a second webpage icon with a second webpage of the website, wherein the second webpage icon corresponds to a degree of significance of the second webpage;
positioning the first webpage icon in a first area of the map view data;
positioning the second webpage icon in a second area of the map view data;
wherein the first webpage icon is different than the second webpage icon;
wherein the degree of significance of the first webpage is different than the degree of significance of the second webpage;
wherein the first webpage icon is communicative of the degree of significance of the first webpage; and
wherein the second webpage icon is communicative of the degree of significance of the first webpage.

2. The method of claim 1, further comprising transmitting the map view data for presentation on a display.

3. The method of claim 1, wherein the first webpage icon is larger than the second webpage icon.

4. The method of claim 1, wherein the first webpage icon comprises a depiction of a first building, and wherein the second webpage icon comprises a depiction of a second building different than the first building.

5. The method of claim 1, further comprising:
positioning, proximate to the first webpage icon, text associated with the first webpage of the website; and
positioning, proximate to the second webpage icon, text associated with the second webpage of the website.

6. The method of claim 1, further comprising:
associating a third webpage icon with a third webpage of the website, wherein the third webpage icon corresponds to a degree of significance of the third webpage;
receiving a zoom-in signal;
in response to the zoom-in signal, positioning the third webpage icon in the first area of the map view data; and
wherein the third webpage icon is communicative of the degree of significance of the third webpage.

7. The method of claim 6, wherein the third webpage icon and the second webpage icon are substantially the same.

8. The method of claim 6, wherein the third webpage icon is smaller than the first webpage icon.

9. The method of claim 6, wherein the first webpage and the second webpage are at different levels of the website, and wherein the level of the first webpage is higher than the level of the second webpage.

10. The method of claim 6, further comprising
receiving a zoom-out signal;
in response to the zoom-out signal, removing the third webpage icon.

11. The method of claim 1, further comprising:
positioning a perimeter representation around the first area of the map view data; and
positioning a perimeter representation around the second area of the map view data.

12. The method of claim 1, further comprising:
in response to an icon interaction signal associated with one of the icons, loading webpage data from the corresponding webpage.

13. The method of claim 12, further comprising transmitting the webpage data for presentation on a display.

14. The method of claim 1, further comprising:
positioning, proximate to the first webpage icon, a first social icon; and
positioning, proximate to the second webpage icon, a second social icon.

15. The method of claim 14, further comprising:
in response to a first social icon interaction signal, loading first social view data;
in response to a second social icon interaction signal, loading second social view data;
wherein the first social view data includes social information generated by a plurality of users while they were visiting the first webpage; and
wherein the second social view data includes social information generated by a plurality of users while they were visiting the second webpage.

16. A method for generating container view data representative of at least a portion of a website, the method comprising:
associating a first container icon with a first webpage of the website, wherein the first webpage corresponds to a first level of the website;
associating a second container icon with a second webpage of the website, wherein the second webpage corresponds to a second level of the website;
nesting the second container icon within the first container icon;
including the first container icon in the container view data;
in response to a first type of icon interaction signal associated with the first container icon, including the second container icon in the container view data.

17. The method of claim 16, further comprising transmitting the container view data for presentation on a display.

18. The method of claim 16, further comprising:
in response to a second type of icon interaction signal associated with the first container icon, obtaining webpage data for the first webpage of the website.

19. The method of claim 18, further comprising transmitting the webpage data for presentation on a display.

20. The method of claim 16, further comprising:
positioning, proximate to the first container icon, a first social icon; and
positioning, proximate to the second container icon, a second social icon.

21. The method of claim 20, further comprising:
in response to a first social icon interaction signal, loading first social view data;
in response to a second social icon interaction signal, loading second social view data;
wherein the first social view data includes social information generated by a plurality of users while they were visiting the first webpage; and
wherein the second social view data includes social information generated by a plurality of users while they were visiting the second webpage.

22. A method for generating search result view data, the method comprising:
including, in the search result view data, a plurality of rows;
wherein at least a portion of the plurality of rows each comprise:
information descriptive of a webpage,
at least one of a map view icon or a container view icon,
wherein the map view icon corresponds to a map view of the website, and
wherein the container view icon corresponds to a container view of the website.

23. The method of claim 22, further comprising transmitting the search result view data for presentation on a display.

24. The method of claim 22, wherein the at least a portion of the plurality of rows each comprise a social icon.

25. The method of claim 22, further comprising:
receiving a map view icon interaction signal with the map view icon; and
responsively including, in the search result view data, map view data corresponding to the website.

26. The method of claim 25, wherein the map view icon interaction signal comprises a signal indicating a pointer hovering over the map view icon.

27. The method of claim 22, further comprising:
receiving a container view icon interaction signal; and
including, in the search result view data, container view data corresponding to the website.

28. The method of claim 27, wherein the container view icon interaction signal comprises a signal indicating a pointer hovering over the container view icon.

29. The method of claim 22, wherein the information descriptive of the webpage comprises a hyperlink to the webpage and an abstract of the webpage.

30. A method for facilitating social communications associated with at least one webpage, the method comprising:
including, in search result view data, a first row comprising information descriptive of a first webpage and a first social icon;
including, in the search result view data, a second row comprising information descriptive of a second webpage and a second social icon;
wherein the first social icon indicates that a plurality of users is interacting in conjunction with the first webpage; and
wherein the second social icon indicates that no users are interacting in conjunction with the second webpage.

31. The method of claim 30, further comprising transmitting the search result view data for presentation on a display.

32. The method of claim 30, wherein the first social icon indicates a number of users that are interacting in conjunction with the first webpage.

33. The method of claim 32, wherein the first social icon indicates a number of users that are interacting in conjunction with a first website containing the first webpage.

34. The method of claim 30, wherein the first social icon and the second social icon have different appearances.

35. The method of claim 30, further comprising:
receiving a first social icon interaction signal through the first social icon; and
in response to receiving the first social icon interaction signal, including in social communications data, a dialogue area for presenting social communications between users.

36. The method of claim 35, further comprising, in response to receiving the first social icon interaction signal, obtaining webpage data corresponding to the first webpage.

37. The method of claim 36, wherein the markup language comprises hyper-text markup language (“HTML”).

38. The method of claim 37, further comprising transmitting the social communications data and the webpage data for presentation on a display.

39. A method for facilitating social communications associated with at least a first webpage and a second webpage, wherein the method comprises:
associating first social view data with first webpage view data to form first associated data;
associating second social view data with second webpage view data to form second associated data, wherein the second social view data is different from the first social view data, and
wherein the second webpage view data is different from the first webpage view data;
wherein the first social view data includes social communications received from a first plurality of users visiting the first webpage; and
wherein the second social view data includes social communications received from a second plurality of users visiting the second webpage, wherein the first plurality of users is different from the second plurality of users.

40. The method of claim 39, further comprising:
transmitting the first associated data for presentation on a display;
subsequently receiving a navigation signal to navigate to the second webpage; and
responsively transmitting the second associated data for presentation on the display in place of the first associated data.
